(19) United States
(12) Patent Application Publication
(10) Pub. No.: US 2003/0236795 A1
(43) Pub. Date: Dec. 25, 2003

(54) Method and system for identifying objects

(76) Inventors: Thomas D. Kemp, Oxford (GB); David Sonnenberg, Tenafly, NJ (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/275,028

(22) PCT Filed: May 3, 2001
(86) PCT No.: PCT/US01/14348

(51) Int. Cl. G06F 7/00

(52) U.S. Cl. 707/104.1

(57) ABSTRACT

A system and method for identifying objects based upon Primitives is provided. The system utilizes a server (2) connected via a network (4) to user terminals (6) from which request are inputted for an identification of objects associated with identified Primitives. The system utilizes various databases to identify objects. Object database (12) stores object records in a search range. Descriptor database (14) stores associations of descriptor dimensions with Primitives. Custom database (40) allows users to describe descriptors in terms of custom Primitives Strand database (38) provides associations of descriptors scriptors across a palette. One embodiment of the method comprises storing records of objects with Primitives that define the objects, displaying a palette identifying types of objects with descriptors, storing with each descriptor at least one Primitive which defines the descriptor, determining a selection of one descriptor from the palette and identifying objects having at least one Primitive associated with the selected descriptor.

### CROSS-REFERENCE TO RELATED APPLICATIONS

This application claims priority from European Patent Application No. 00303689.4, filed May 3, 2000, by Hunter Douglas Industries B. V., entitled “Method and System for Identifying Products”, and from U.S. Provisional Patent application Serial No. 60/253,167, filed Nov. 27, 2000, in the name of inventors Thomas D. Kemp and David Sonnenberg, entitled “Method and System for Identifying Products; the contents of both of which are hereby incorporated by reference.

### FIELD OF THE INVENTION

The present invention relates to a method and system for identifying objects. More specifically, the present invention provides a method and system for identifying objects of a selected type from a range of objects based upon the provisioning of at least one primitive identifying a type of object desired.

### BACKGROUND OF THE INVENTION

It has been known previously to store records of a range of objects, together with associated attributes. A user is able to search these records for particular attributes so as to identify objects of a desired type. For example, it is possible to store a database containing a range of cars for sale. Each car may have associated with it attributes defining, for example, the model, make, engine size and color. A user can then define the attributes of interest and search the records to identify cars of the desired type. Although this system can work effectively for some objects, it does have limitations.

For objects such as fabrics and home furnishings, there are no clear attributes to define the objects and allow the user to specify a desired type of object. Terms used to define these types of object are generally broad subjective terms. For instance, a user may wish to identify objects having a “Victorian” design. This term may have one meaning in the United Kingdom, for example, and different meanings elsewhere. Similarly, terms used for designs may vary from season to season according to fashion. It is impractical to provide records of all of the objects showing the different attributes for different countries and also to change the records season by season. Therefore, a method and system is needed which allows a user to define a desired object in terms familiar to the user, which may then be converted into terms common to suppliers of objects matching the user's definition, but not necessarily characterized in the same way. More specifically, a method and system is needed which describes objects or services (hereafter, collectively “objects”) and user requests for objects in terms of objective characteristics (hereafter, “Primitives”) such that objects meeting or possessing certain characteristics may be described and identified via their associated Primitives.

### SUMMARY OF THE INVENTION

According to the present invention, there is provided a method of identifying objects of a selected type from a range of objects, the method comprising:

storing records of respective objects of a range of objects together with associated Primitives which define characteristics of the objects;

displaying a classification palette including a plurality of descriptors for identifying respective types of objects;

storing, in association with each descriptor, at least one Primitive for defining the characteristics of the descriptor;

determining selection of one of the descriptors in the classification palette, and

identifying objects having at least one Primitive associated with the selected descriptor.

According to the present invention there is also provided a system for identifying objects of a selected type from a range of objects, the system comprising:

a first memory for storing records of respective objects of a range of objects together with associated Primitives which define characteristics of the objects;

an image generator for providing for display a classification palette including a plurality of descriptors for identifying respective types of objects;

a second memory for storing, in association with each descriptor, at least one Primitive for defining the characteristics of the descriptor;

an input sensor for determining a selection of one of the descriptors in the classification palette; and

a controller for searching the stored records to identify objects having at least one Primitive associated with the selected descriptor.

Preferably the system further comprises a user interface including a display for displaying images provided by the image generator and an input for providing an input selection.

The system may be for use over a network and include a server having at least the first memory.

At least one user terminal may be provided on the network including the user interface.

Preferably the image generator, second memory, input sensor and controller are also provided in the server. However, it is possible to distribute these components as required between the server and the user terminal.

In this way, records of the complete range of objects may be kept together with Primitives which define objective unchanging characteristics of the objects, such as color content, formality and fussiness of the design, whether patterned or not, and size of pattern. Based on the same range of Primitives, descriptors for use by the user can be defined. These descriptors can vary from season to season, from country to country and from user to user while still using the same object records.

Preferably Primitives for defining related characteristics are associated together in dimensions. Where Primitives of a particular dimension define characteristics which are different degrees of a single property, the Primitives of the particular dimension may be associated in order of degree.

Preferably the characteristics of at least one descriptor are defined by at least one range of Primitives within a dimension.

Thus, by arranging Primitives of related properties in dimensions, it becomes easier for a user to understand how Primitives within a particular property relate to the various characteristics of that property. For a particular property, it becomes unnecessary for the user to individually identify and understand the Primitives and it is sufficient to pick a range within the minimum and maximum possible values of the property under consideration.

The characteristics of at least one descriptor may be defined by Primitives from a plurality of dimensions.

In this way, the dimensions together form a classification space within which multi-dimensional volumes may be defined to describe the descriptors.

In a similar way, the characteristics of at least one object may be defined by at least one range of Primitives within a dimension, and the characteristics of at least one object may be defined by Primitives from a plurality of dimensions.

Objects may be identified according to whether the respective ranges of Primitives for the selected descriptor overlap, are contained within, or are identical to the corresponding ranges of Primitives of the objects.

Preferably, the operation of comparison may be specified by the user. Further, preferably, it can be specified individually for different dimensions.

Preferably, a plurality of different classification palettes are selectively displayed, and each classification palette includes a respective plurality of descriptors.

In this way, different classification palettes may be provided, for example, for different aspects of the nature of the objects or for different countries. Indeed, it would be possible for a user to define custom descriptors having user defined Primitives and to arrange these together in a custom classification palette.

Each classification palette may have an associated classification space including a respective plurality of dimensions wherein the characteristics of each descriptor of a classification palette are defined by ranges of Primitives in the dimensions of the respective classification space.

Preferably, each one of the plurality of dimensions defining a particular descriptor is displayed as an array of the Primitives for that dimension together with a slider which may be moved to alter the range or selection of Primitives associated with the dimension.

The slider may be one or more bars movable alongside the array of Primitives or may comprise one or more highlighted Primitives.

In this way, the user is provided with a visual description of all of the Primitives within the various dimensions defining a descriptor.

Furthermore, by moving the sliders, the user can easily modify the selection of Primitives and hence the characteristics of a descriptor. The modified descriptors may be stored as custom descriptors and/or may be used to modify the search to identify objects.

Of course, the term “object” is used mostly with respect to physical objects. However, it is also intended to cover other items such as services. As such, the present invention provides a system and methodology which allows a user to describe an object utilizing a first set of terms and then identify objects provided by others which may be described using a second set of terms.

### BRIEF DESCRIPTION OF THE DRAWING FIGURES

FIG. 1 illustrates a system embodying a preferred embodiment of the present invention.

FIG. 2 illustrates the server of FIG. 1 according to a preferred embodiment of the present invention.

FIG. 3 illustrates an object record according to a preferred embodiment of the present invention.

FIG. 4 illustrates a descriptor record according to a preferred embodiment of the present invention.

FIG. 5 illustrates a classification palette according to a preferred embodiment of the present invention.

FIG. 6 illustrates a classification space according to a preferred embodiment of the present invention.

FIG. 7 illustrates a color classification space according to a preferred embodiment of the present invention.

FIG. 8 illustrates a graphical representation of a data structure utilized in the preferred embodiment to match and identify objects.

FIG. 9 illustrates a graphical representation of a second data structure utilized in an alternative embodiment to match and identify objects.

FIG. 10 illustrates the associations in a data structure between Objects, Cuboids, Strands, Ranges, and Dimensions for a preferred embodiment of the present invention.

FIG. 11 illustrates a structure for a SearchGroup utilized by one embodiment of a search engine for the present invention.

FIG. 12 illustrates a method by which one embodiment of the present invention builds a search table to be utilized by a search engine.

FIG. 13 illustrates the structural relationships between a search engine and a search group for one embodiment of the present invention.

FIG. 14 illustrates one embodiment of a structural design of a search engine for the present invention.

FIG. 15 illustrates a screen shot of a Home Page for an Internet based embodiment of the present invention utilized to identify a tapestry desired by a user.

FIG. 16 illustrates a screen shot of a Member Home page which is suitably displayed to a user upon signing in using the Internet based embodiment identified in FIG. 15.

FIG. 17 illustrates a screen shot of a Basic Search page provided in conjunction with the Internet based embodiment identified in FIG. 15.

FIG. 18 illustrates a screen shot of a Search by Reference page provided in conjunction with the Internet based embodiment identified in FIG. 15.

FIG. 19 illustrates a screen shot of a Color Search page provided in conjunction with the Internet based embodiment identified in FIG. 15.

FIG. 20A illustrates a screen shot of a Secondary Color Search page provided in conjunction with the Internet based embodiment identified in FIG. 15.

FIG. 20B illustrates a screen shot of a color contrast pages provided in injunction with the Internet based embodiment identified in FIG. 15.

FIG. 21 illustrates a screen shot of a Composition Selection page provided in conjunction with the Internet based embodiment identified in FIG. 15.

FIG. 22 illustrates a screen shot of a Composition (application) Selection page provided in conjunction with the Internet based embodiment identified in FIG. 15.

FIG. 23 illustrates a screen shot of a Design (dimension) Search Selection page provided in conjunction with the Internet based embodiment identified in FIG. 15.

FIG. 24A illustrates a screen shot of a Design (descriptors) Search Selection page provided in conjunction with the Internet based embodiment identified in FIG. 15.

FIG. 24B illustrates a series of slides which may be utilized to specify a type of fabric for the Internet based embodiment identified in FIG. 15.

FIG. 25 illustrates a screen shot of a Workboard page provided in conjunction with the Internet based embodiment identified in FIG. 15.

FIG. 26 illustrates a screen shot of a View page provided in conjunction with the Internet based embodiment identified in FIG. 15.

FIG. 27 illustrates a screen shot of a Drape View page provided in conjunction with the Internet based embodiment identified in FIG. 15.

FIG. 28 illustrates a screen shot of an Upholstery View page provided in conjunction with the Internet based embodiment identified in FIG. 15.

FIG. 29 illustrates a screen shot of a Full Repeat View page provided in conjunction with the Internet based embodiment identified in FIG. 15.

FIG. 30 illustrates a screen shot of a Multiview page provided in conjunction with the Internet based embodiment identified in FIG. 15.

### DETAILED DESCRIPTION OF THE INVENTION

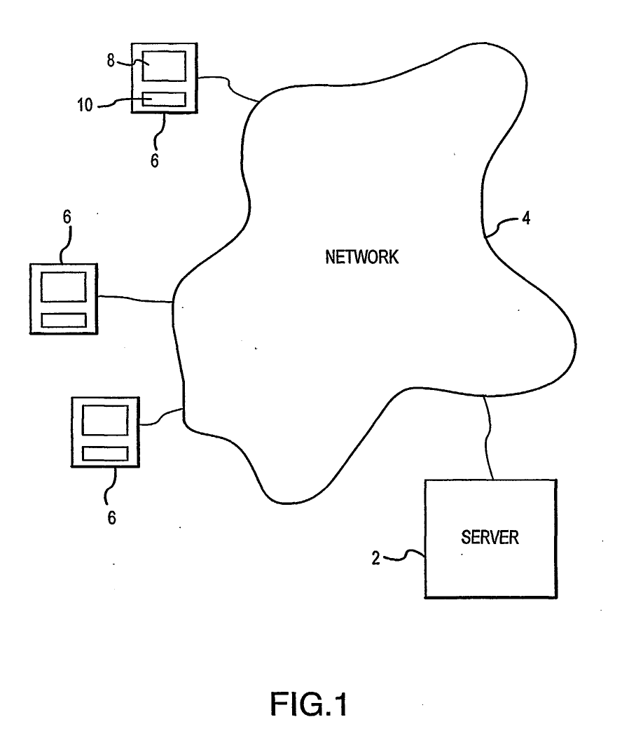

The present invention is preferably embodied on a network 4, as illustrated in FIG. 1. In particular, the present invention may be embodied in a server 2 connected on a network 4, such as the Internet. End users may make use of the server 2 remotely by means of terminals 6 having user interfaces with displays 8 and input keys 10. Of course, the present invention could also be embodied as a stand alone unit, having its own display and input keys. Additionally, the present invention may also be embodied on a distributed network, as a single purpose device (for example, a kiosk at a home furnishings store) which includes a database of providers of objects satisfying user defined Primitives, or via any other system or network configuration. Similarly, the present invention may utilize any communications systems available to provide the features and functions identified herein. Such communications systems include the Internet, intranets, private networks, public networks, telecommunication networks (both wired and wireless), and any other suitable system which provides for the communication of data between a user and a system implementing the present invention.

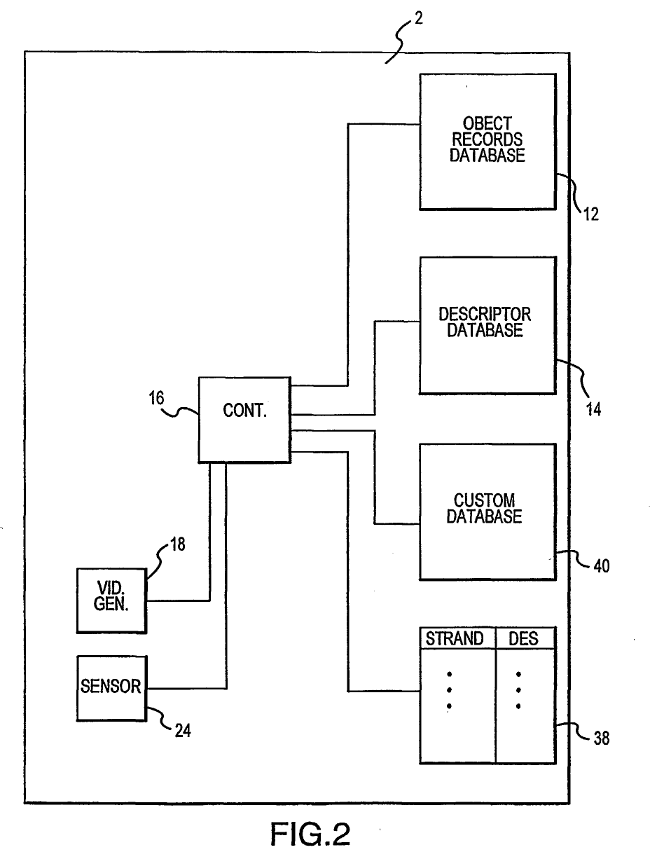

Referring again to the preferred network embodiment shown in FIG. 1, the matching features and functions of the present invention are preferably provided by the server 2. As shown in FIG. 2, the server 2 includes various functional components which may be embodied in hardware and/or software, as is commonly known in the art. One such functional component is an object records database 12, which includes a database for storing records of each object in the range to be searched. Another functional component is the descriptor database 14, which suitably includes a memory for storing associations of descriptor dimensions with Primitives. The server 2 further preferably includes a custom database 40 which allows a user to describe a descriptor in terms of custom Primitives rather than pre-set or pre-defined Primitives. Further, the server 2 includes at least one strand database 38 which provides associations of descriptors across a palette, as is explained in greater detail herein.

In addition to the various functional components, the server 2 also preferably includes various physical components including a controller 16 which receives inputs from a user (preferably via a user terminal 6 over the network), determines from which of the various databases searches are to be conducted, executes such searches, and generates results. Additionally, the server 2 includes a video driver 18 which may be used to produce a display on a local display screen or to produce display information to be transmitted over the network and displayed on a remote display 8. Lastly, the server 2 preferably includes a sensor 24 which enables a user to interact with the server either directly or remotely. The sensor 24 may be any device which enables a user to specify search descriptors and/or Primitives to the server. Such devices include voice recognition devices and software, audio input devices (for example, to receive a sample of an artist whose additional works are desired), manual input devices (for example, a keyboard, mouse, trackball, and pointer), optical recognition devices (for example, scanners, bar code readers, textile analyzers, spectrophotometers, and various other character recognition hardware and software devices), and any other device which enables one to specify at least one descriptor to the server 2.

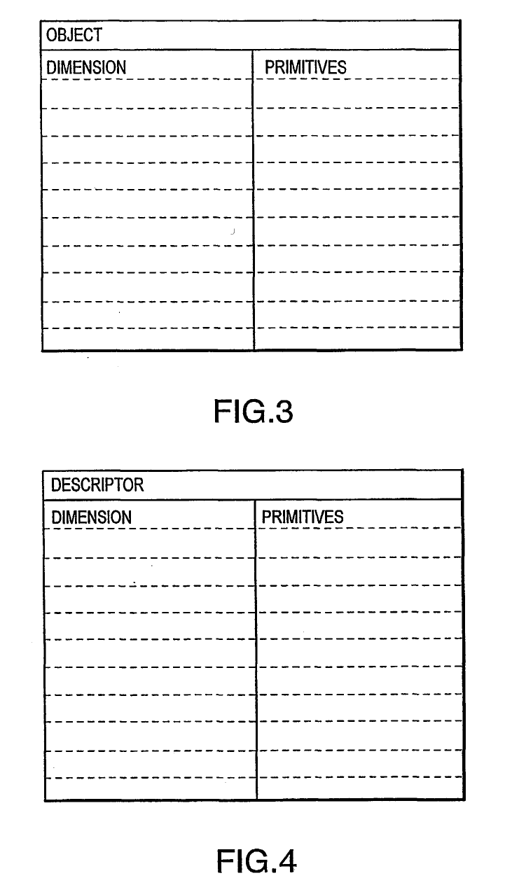

As mentioned above, the server 2 also preferably includes an object records database 12. FIG. 3 illustrates an example of a record for one object in the object records database. As shown, each record is intended to provide a list of objective characteristics (i.e., Primitives) for each respective object.

One example of a range of objects is a range or selection of fabrics. These may come in a range having different colors (i.e., the different colors to be found in the fabric), compositions (i.e., the way the fabric is made and its characteristics), different design (i.e., the aesthetics of the design), and different supply characteristics, (i.e., the aspects of buying and selling the fabric). Various and often numerous Primitives are used to define all of the different aspects of a specific type of fabric. Additionally, for a particular range of objects, a predetermined list of Primitives is prepared from which all fabrics/objects within that range can be defined. New fabrics/objects may be added to the range and are preferably defined by the same set of Primitives. Lastly, additional Primitives may be added, where necessary, to describe new fabrics/objects or better describe existing fabrics/objects.

For example, Primitives defining a set of fabrics/objects could include Primitives defining all colors, material types, characteristics (such as the nature of the weave), and aspects of buying and selling the fabric (such as availability and price). Other Primitives could define the design of the fabric and may include specific Primitives such as “stately,” “formal,” “refined,” “whimsical,” “informal,” “casual” and “shabby.”

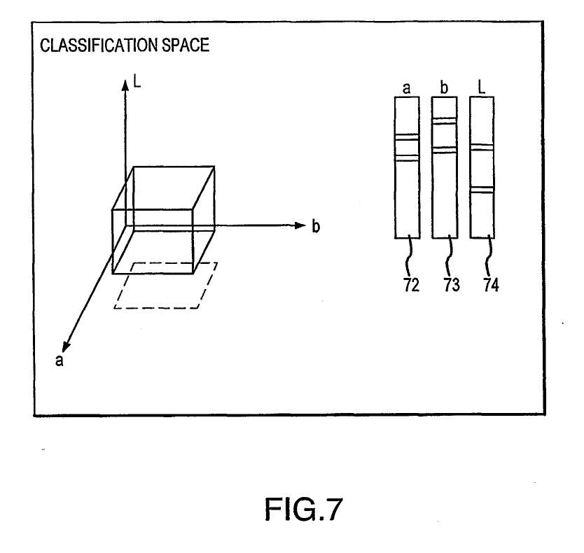

Many Primitives relate to the same type of characteristic. For example, color may be defined using the “color space” known as CIELAB (an illustration of which is shown in FIG. 7). This is a three dimensional space where the first axis (the “a” axis) has green at one extreme and red at the other, the second axis (the “b” axis) runs from blue to yellow and the third axis (the “L” axis) indicates the lightness of a color, running from black to white. The Primitives for defining the color include three sets of Primitives running in each of the axial directions. Hence, the Primitives are associated together in groups which will be described as “Dimensions.” Since the color of a particular object may be measured, for instance using a spectrophotometer, the record for a particular object of a particular color generally will include one Primitive in each of the three color Dimensions. Additionally, a fourth axis, the Intensity axis, may also be utilized to define a color. The Intensity axis provides an indication of the brightness of a color along a predefined range.

In a similar way, for defining the design of a object, the present invention supports the use of other Dimensions and Primitives such as a “formality” Dimension which may include the following Primitives: stately, formal, refined, whimsical, informal, casual and shabby. Since these Primitives all represent degrees of formality, it is preferable that they are arranged in the Dimension in the order of their degree of formality. In this way, an object may be defined by a range of the Primitives within the Dimension. Indeed, it is not always necessary to have individual Primitives, since they may often merely represent the “degree” of a property represented by their Dimension. Those skilled in the art appreciate that depending upon processing speeds and database availability, any object may be defined my numerous Dimensions and Primitives to any desired level of detail and/or precision.

Referring again to FIG. 3, it will be seen that each object record defines the characteristics of the object by reference to all of the Primitives which best define that object. Preferably, related Primitives are arranged together in Dimensions and, where the Primitives are ordered within the Dimensions, ranges of Primitives can be defined. An object is thus defined by one or more points of volumes in the multi-dimensional space defined by the Dimensions.

Additionally, since objects are usually described with terms which are fairly subjective and ephemeral and have complex meanings, the present invention suitably allows the user to define a desired object by using their “own” terms (herein, “Descriptors”), as provided by the Descriptor database 14 (FIG. 2). For example, in the field of fabrics, a user might refer to a “Victorian” design as generally consisting of beige colors printed on man-made fibers. The terms “Victorian,” “beige” and “man-made” all encompass ranges of specific characteristics of an object (for example, a fabric), but would nevertheless identify recognized types of such objects.

To accommodate the various Descriptors, the present invention defines a series of Descriptors and stores them in a database 14 containing records which define the characteristics of the Descriptors. A possible arrangement for such a record is illustrated in FIG. 4. The characteristics of the Descriptors are defined in a manner similar to the characteristics of the objects. In particular, they are defined in terms of Primitives which may be arranged in Dimensions.

It will be appreciated that the Primitives used to define the characteristics of the objects will often be single Primitives, such as a particular material or type of weave. In contrast, by the nature of Descriptors being subjective, ranges or selections of Primitives will usually be used to define the Descriptors.

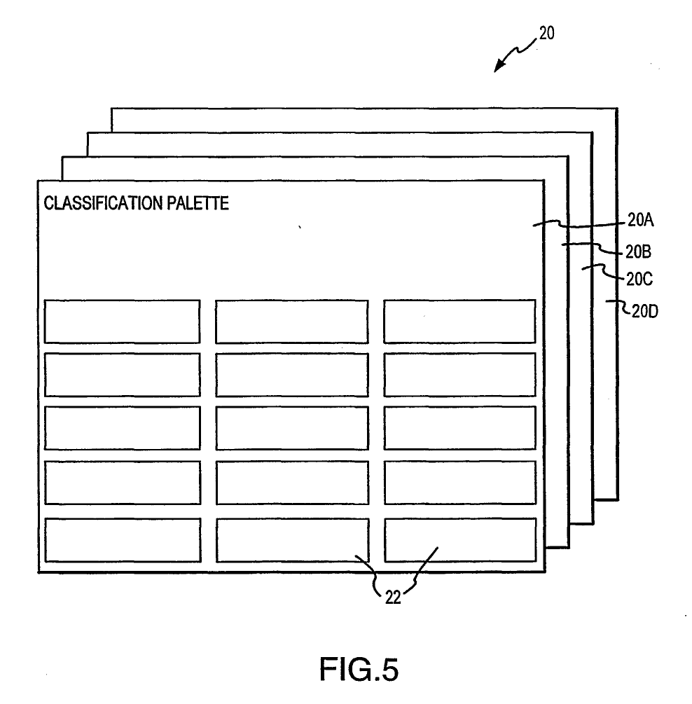

Referring again to FIG. 2, based upon the Descriptors selected by a user, the controller 16 searches for objects of a type defined by a particular Descriptor by determining the Primitives defining the characteristics of that Descriptor and searching for those Primitives in the object records database 12. In order to facilitate the entry and selection of Descriptors, the controller 16 preferably directs the video driver 18 to produce and display a classification palette 20 (FIG. 5). The classification palette 20 preferably includes a plurality of Descriptors 22 which may be selected by a user. In particular, either locally or remotely, a user may select one of the Descriptors 22 using input keys, for instance on a keyboard or a mouse. The user is provided with a plurality of

Descriptors having broad meanings. Each of these can be selected by the user and encompasses a wide variety of characteristics defined by Primitives. The controller 16, using a sensor 24, determines a selection of a particular Descriptor and then searches the object records database 12, as described above.

As illustrated in FIG. 5, a plurality of classification palettes 20A, 20B, 20C, 20D may be selectively available, as necessary, for display. Each classification palette preferably includes a different selection of Descriptors. More specifically, four classification palettes are provided: one each for color, composition, design and supply, respectively. As will be discussed further below, a great variety of classification palettes may be provided. For instance, different classification palettes may be provided for different countries according to current fashions in those countries. Similarly, customized classification palettes may be provided for individual users including the Descriptors required for those users. Further, any number of palettes may be utilized depending upon the objects, database specificity, degree of precision, or any other variable. The present invention is not limited to pre-set palette classifications, numbers of palettes, or arrangements of palettes. Additionally, the present invention is not limited to a fabrics and/or fashion embodiment Is it to be appreciated that the present invention may be utilized to identify, classify, search, and find any objects or services which possess an abstract component or feature. Examples of objects/services possessing abstract components or features include, but are not limited to, motion pictures, still pictures, music (both live and pre-recorded), objects of art or history, jewelry, dating services, medical services, and legal services.

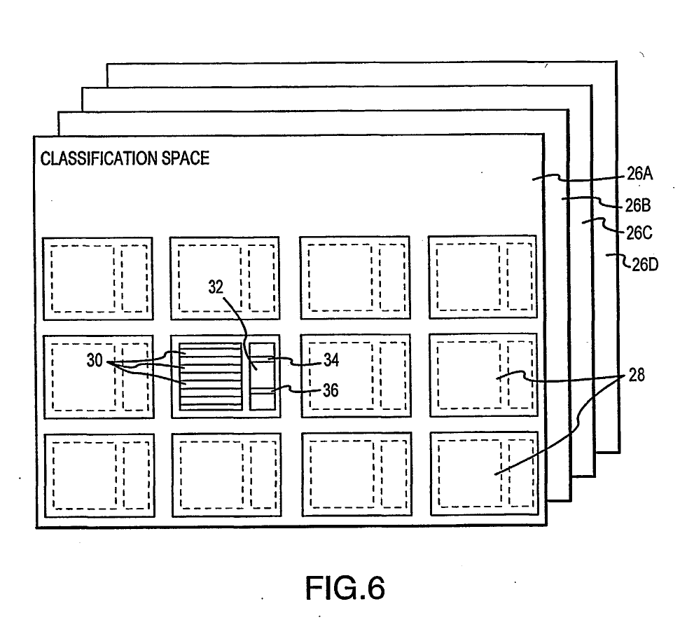

According to a preferred embodiment, all of the Descriptors used in a single classification palette have their characteristics defined using the same selection of Dimensions and Primitives. Further, the preferred embodiment provides a classification space associated with each respective classification palette. FIG. 6 illustrates an example of such a classification space.

In each classification space, all of the Dimensions 28 required for defining the characteristics of the Descriptors 22 of the corresponding classification palette are displayed. For each Dimension 28, all of its Primitives are listed in order alongside a slider 32. Thus, upon selecting a particular Descriptor 22 in the classification palette 20 a (see FIG. 5), the corresponding classification space (for example, 26A, 26B, 26C and 26D of FIG. 6), will indicate the Primitives defining the characteristics of the selected Descriptor by means of the sliders 32 adjacent to the Primitives 30.

Preferably the sliders 32 include upper levels 34 and lower levels 36 which define the upper and lower extremes of the range of Primitives selected for the respective Dimension 28. Each classification palette and its associated classification space is identified herein as a “Strand.”

Referring to FIG. 2, it will be seen that a database 38 is provided for storing a record of all of the Descriptors associated with each Strand. As is commonly known in the art, the database 38 may be local or remote to the controller 16 and may be accessed via any appropriate system or network (for example, the Internet, intranet, private network, and public network) and may be provided on any device (for example, a hard disc drive, a network server, a compact disc, and a digital versatile disc). Thus, when a user selects a particular classification palette of a respective Strand, the controller 16 determines the Descriptors and dimensions required for that Strand and directs the video driver to display the appropriate classification palette.

According to a preferred embodiment, the levels 34 and 36 of the sliders 32 can be moved. Hence, when the system displays a classification space as illustrated in FIG. 6, a user can alter the Primitives of a particular Descriptor before the identification search is conducted. In this way, a user can modify a search to look for objects having a broader, narrower or different range of characteristics than the type specified by the Descriptor.

Additionally, the system is preferably provided with a database 40 (FIG. 2) for storing custom Descriptors. Thus, using a classification space as illustrated in FIG. 6, a user may adjust the upper and lower levels of the ranges of Primitives for each Dimension to provide a particular definition for a Descriptor. This Descriptor may then be stored in the custom database 40. Similarly, a custom Strand may be stored in the database 38 including reference to the custom Descriptors. In the preferred embodiment, all of the custom Descriptors for a particular custom Strand would use the same selection of Dimensions.

The classification space of FIG. 6 may appear in various forms. For instance, the upper and lower levels of the Primitives 30 of a Dimension 28 may appear as highlighted Primitives themselves, rather than the adjacent bars illustrated in FIG. 6. Alternatively, the range can be indicated by a bar extending between the upper and lower levels, either adjacent to the Primitives or over them as some form of highlighting. It is not necessary for the Primitives to be identified specifically by name in the classification space. For example, since a particular Dimension may relate to the ornateness of a design or the fire retardant ability of an object, the Dimension can be described as “ornateness” or “fire retardant” and the upper 34 and lower 36 levels positioned as required between the minimum and maximum possible values for these Dimensions.

FIG. 7 illustrates an alternative scheme for a classification space. In particular, FIG. 7 illustrates a scheme for defining colors utilizing a CIELAB color space. As shown, the color classification palette will include a plurality of different colors defined by words or illustrated by example colors. Although only one color will be indicated by the Descriptor, usually a variety of colors around that color would be of interest to the user.

As mentioned above, the CIELAB color space has three Dimensions, a, b, and L. Hence, the particular color illustrated or described by the color Descriptor will be a particular point in the color space defined by Primitive values a, b and L for the three Dimensions. However, since, as mentioned above, the user will require colors around that particular value, the characteristics of the Descriptor will be defined by ranges of Primitives in the three Dimensions. Since there are only three Dimensions for the color, rather than the many Dimensions which may be used for other Descriptors, it is possible to illustrate the classification space defined for a Descriptor graphically as a three dimensional space.

As shown by the space illustrated in FIG. 7, each Dimension follows the values defined by the ranges of Primitives. However, other arrangements are also possible. The defined volumes may also be spherical or ellipsoidal to provide a more accurate representation of a user's perception. In this respect, rather than or as well as providing the three adjustment bars 72, 73, 74 illustrated in FIG. 7, the system allows the user to drag the illustrated color volume so as to alter its size, shape and position. Alternatively, adjustment bars could be provided for size, shape and position. Additionally, it is to be appreciated that more intuitive ways of adjusting the color other than the a, b, and L values exist, any of which may be utilized, as desired.

Since the perceived range of colors close to a particular color varies according to the particular color in question, preferably, the color volume generated for each color Descriptor varies in size depending on the position of the particular color in the color space. Thus, the default settings for color Descriptors may contain varying volumes according to the position of the basic color in the color space.

However, the present invention is not limited to using the CIELAB color classification scheme, and may utilize other schemes, as desired. For example, a user may wish to utilize a Color classification scheme which recognizes four Dimensions (i.e., the “a,” “b,” and “L” dimensions used in CIELAB plus a fourth Dimension for intensity). Upon determining the color classification scheme desired to be used, the user then must determine how to specify a color in an object, for example, with multiple shades of color. In the preferred embodiment, this classification is accomplished by identifying three “levels” of color, i.e., the dominant color, the secondary color and a highlight color. This embodiment assumes that a color is only recorded once (i.e., a color cannot be both the dominant and secondary color). Similarly, this embodiment assumes that a user is not concerned with minute differences between colors and thus utilizes a grouping scheme to classify colors.

Further, for the preferred embodiment a user may enter color information via one of two methods. The first method is to capture an RGB image of the object using, for example, a digital camera, a digital scanner, or similar devices. Once the RGB image exists, the user then selects specific areas of the captured object to represent one of the three color levels. At this point the imaging software then measures the RGB values for the selected area, averages the value, and obtains a single RGB value which is then converted into a CIELAB value. The classifying software then calculates the proportion of the object which is the color first selected, including those colors which are considered to be the same as the selected color even though, in reality, they are slightly different. By repeating this process for each of the colors (dominant, secondary, and highlight), the system generates a point in a twelve dimension color space (i.e., each color has three dimensions plus there are three colors (red, green, and blue) and the intensity dimension). More specifically, in the 12-tuple, the first four values represent the dominant color, the second four values represent the secondary color, and the last four values represent the highlight color.

A second method for measuring the amount of color in a object which may be utilized by the present invention, is to use a spectrophotometer, the usage of which is well known in the art. Based upon the readings of the spectrophotometer, the readings of the three color levels are obtained. While the present invention has been described in the context of obtaining measurements for three colors, it is to be appreciated that additional or fewer color measurements may be utilized, if at all, in identifying and matching objects.

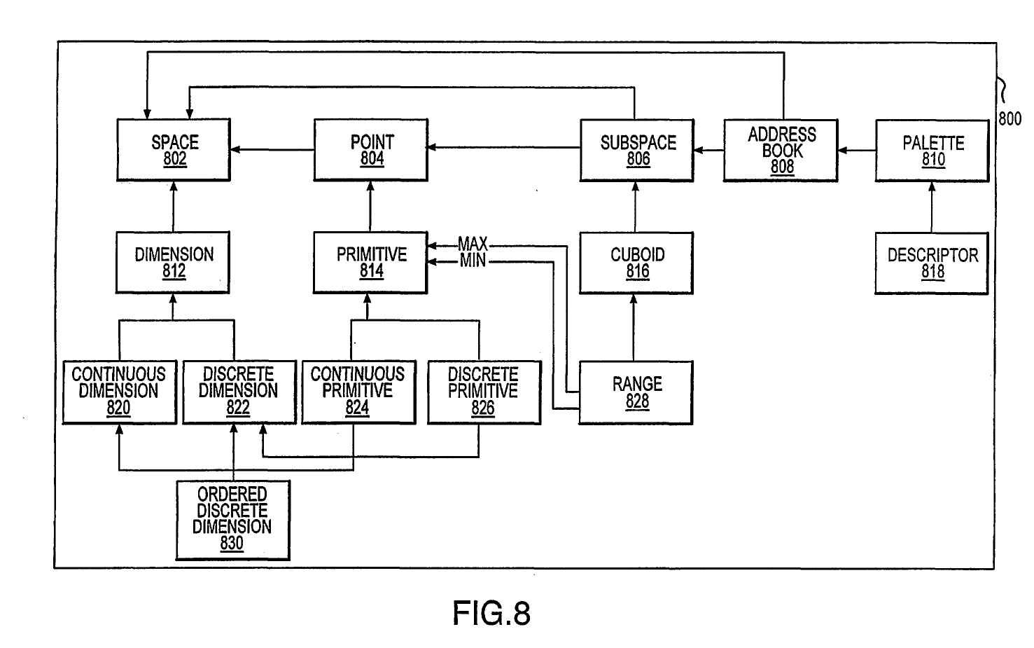

As mentioned previously, the present invention preferably utilizes a data structure to provide a framework for the classification of objects and requests for identifications thereof. As shown, the data structure is based upon classifying a request based upon a Strand 800 (FIG. 8). For the preferred embodiment, four Strands are utilized: Color, Composition, Design, and Supply. The Strands are part of a classification scheme which allows one to divide a group of objects into meaningful categories and thereby classify objects as members of one or more specific groups. As is well known in the art, once a group of objects is classified, one may then analyze the categories and retrieve objects from the categories.

More specifically, each Strand preferably contains two sides, a classification space 802 and a classification palette 810. The classification palette 810 contains Descriptors 818 which are commonly utilized in the given industry to describe an object. Such terms may come and go as the industry sees fit. For example, the color identified as Midnight Blue may exist one year and may not be available a next year (even though the actual color does not change). As such, Descriptors may change as industry needs dictate.

In contrast, the classification space contains much more objective terms which are not subject to industry, season, or fashion dictates. As mentioned previously, such terms are called Primitives 814. As shown in FIG. 8, two types of Primitives 814 preferably exist: Continuous Primitives 824 and Discrete Primitives 826. A Continuous Primitive 824 is preferably a real number utilized to represent a value upon a range of values, for example, a value utilized to represent a specific shade of green along the red-green axis of a color dimension. A Discrete Primitive 826 is a value which represents a discrete concept or object, for example, a type of material, such as cotton.

Further, each space 802 preferably arranges Primitives in terms of Dimensions 812. A Dimension 812 may contain a list or hierarchy of Primitives and represent a single aspect of a Descriptor in a palette. Additionally, a Dimension 812 is either a Continuous Dimension 820 or a Discrete Dimension 822. As for the Primitives, the Continuous Dimension represents a range of values, whereas the Discrete Dimension preferably represents a specific classification or set of classifications.

In addition to specifying Strands in terms of Dimensions and Primitives, the present invention also allows Strands to be defined in terms of Points 804 and Subspaces 806. A Point 804 preferably is a list of Primitives for each dimension in the space. By providing a Point 804, the present invention suitably allows a user to select from all the Primitives, or by using Definitions to select specific Primitives, when either defining an object or inputting a query for an object A Subspace 806 also facilitates the classifying and finding of objects. A Subspace 806 represents two things: (1) a classification for an object; and (2) a query to the controller 16 to find an object. Importantly, the Subspace 806 may be a combination of Cuboids 816. Cuboids 816, which represent n-dimensional cubes in space, may be suitably combined using boolean and other operations into a composite. More specifically, a Cuboid is a collection of related Ranges, where a Range is a set of values associated with a Dimension. For example, a Subspace may be a boolean combination of a texture, color, and durability of an object, wherein each of these variables are represented by Cuboids as a Range 828 of values over a spectrum. The Cuboid preferably provides the area within which the various ranges defining an object intersect. In short, the Subspace allows one to define an object in terms of other Primitives and/or Descriptors.

Lastly, the Strand 800 also includes an Address Book 808. The Address Book 808 provides an association between a Descriptor 818 (whose definition may vary with time, local, and other variables) and a Primitive 814 (whose definition never varies). By classifying objects in terms of the before mentioned structure, the present invention enables one to quickly and efficiently find objects meeting specific criteria For example, in order to determine the flame retardness of a specific type of object, testers commonly have to actually test the object. By utilizing the present invention, such testing may be reduced and/or eliminated since characteristics of specific objects providing the desired level or flame retardness may be identified, classified, and easily located regardless of the name given to such objects over time.

Additionally, it is to be appreciated that the present invention may utilize numerous palettes to describe various objects. By comparing such palettes and the sub-classifications associated therewith, the present invention enables one to analyze differences between palettes and identify trends. Additionally, the classification scheme enables a user to search for objects in terms of Descriptors (for example, Victorian or a given design) and/or in terms of Primitives (e.g., a specific color, texture, composition, or intensity).

As mentioned previously, the present invention preferably utilizes four Strands (Color, Composition, Design, and Supply) to define objects. For the Color Strand, the present invention preferably utilizes the CIELAB color space. However, the present invention may also utilize various other standards well known in the art, such as the Pantone, NCS, RGB, and CMYK, as desired without departing from the spirit or scope of the present invention. Additionally, since a particular color and its next closest neighboring color may contain differences so subtle that the human eye cannot perceive them, the present invention preferably groups such similar colors into “chunks” of color by utilizing CMC Tolerancing, wherein the CIELAB space is suitably cut up into three-dimensional ellipsoids. Such ellipsoids may vary in size and shape to account for perceptible differences between blues and reds, for example, by the human eye. Additionally, tolerance ranges may be utilized to identify like Primitives (or like colors). These tolerance ranges may also be set by individual users, thereby providing compensations for color blindness and other perception difficulties.

The Composition Strand is preferably devised as a two-sided structure. On a first side, the classification space identifies fundamental components of objects, such as the base material and materials added to the base material. Depending upon the level of sophistication provided by a supplier of an object, this classification space may vary over the range of being highly detailed to very vague.

The other side of the Composition Strand identifies, via classification palettes, the resulting characteristics of an object. The characteristics are the direct result of the way in which the object was made. Since for many objects it is impossible to precisely define a characteristic based upon the object's manufacture, Primitives are commonly utilized to describe such objects.

The Design Strand preferably contains a collection of terms commonly used in a given industry to describe object designs. Some of these terms include constant ideas, such as eras which represent designs common for particular historical periods. Other terms (Descriptors) may be more ephemeral and may last for limited time periods. Such terms are commonly referred to as buzzwords or trends. The classification space for the Design strand is preferably quite subtle, such that each Descriptor in a palette may be defined in terms of Primitives in the classification space. For example, the term Victorian may imply a historical period, a level of ornateness, a use of darker colors, or heavy designs. The present invention preferably captures all of these descriptions associated with a term, such as Victorian, by providing Dimensions associated with each description. For example, a Dimension, Temporality, may be used to define a historical period, whereas another Dimension, such as Formality, may be used to define a level of formality in an object. By defining such Dimensions as ranges of Primitives, the present invention allows one to easily associate a specific characteristic with an object Table 1 provides a listing of Dimensions and Descriptors commonly associated with the Design Strand.

The last strand provided in the preferred embodiment and geared to objects, is the Supply Strand. The Supply Strand is preferably one sided and is merely a classification space of Descriptors associated with the buying and selling of an object and does not directly relate to the actual identification of an object matching a user's request. For the fabrics embodiment of the present invention, Table 2 provides a listing of Descriptors commonly associated with such a Supply Strand.

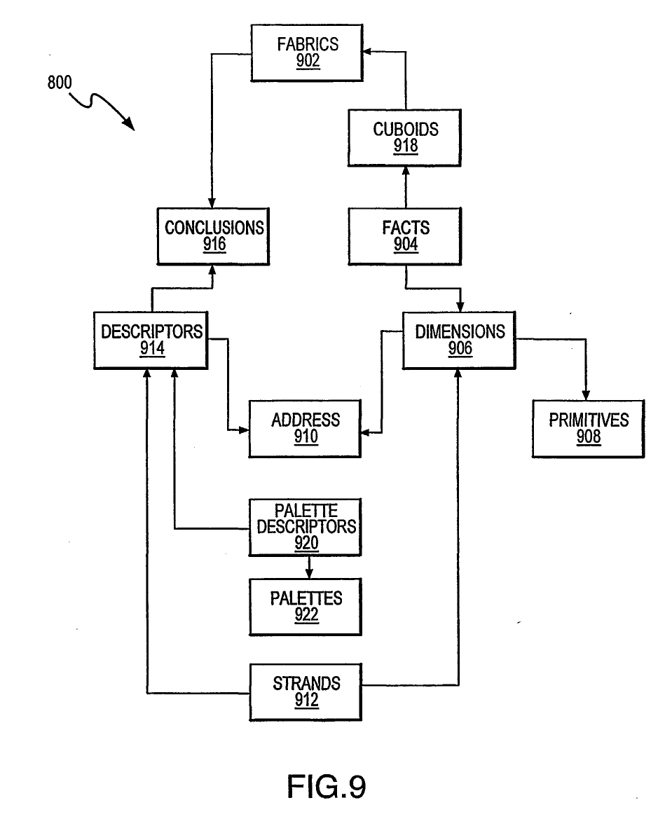

Additionally, the preferred embodiment also supports a Composition Strand. The Composition Strand is suitably provided in a simplified form (see Table 3) and in a fully detailed form (see Table 4). As shown in Table 3, the simplified form allows a producer of an object (for this example, a fabric) to define the object in terms of a limited set of Dimensions and Descriptors. Such Dimensions include components used, construction, finishing, width, thickness, and weight, while the Descriptors include performance, protection, and environment. Similarly, the fully detailed form allows a producer to define an object in more precise terms. While reference has been made to the producers of objects, it is to be appreciated that similar levels of detail may be provided by a purchaser submitting a query for a object. Another embodiment for classifying objects and requests is shown in FIG. 9. As shown, this embodiment is geared towards a fabric classification scheme, however, it is to be appreciated that the embodiment may be utilized for other objects, as desired. In FIG. 9, the diagram arrows represent many-to-one relations between tables (the individual blocks in the diagram) in a database. For example, a table for Fabrics 902 exists as does a table for Dimensions 906. Additionally, it is to be appreciated that many Dimensions, for example, may be attached to each Strand and that each Strand may contain many Descriptors which may contain palettes. As such, the relations between the various data sets are not limited to those shown in FIG. 9. Those skilled in the art appreciate that various connections and data sharing may occur between the blocks/tables in a database, as desired.

More specifically, this embodiment is preferred when one is implementing the most common uses of the fabric classification scheme of the present embodiment. Additionally, it is a more efficient embodiment than previous embodiments when one is dealing with subspaces which are cuboidal and where all dimensions are ordered, because a cuboidal subspace can be described as a list of pairs of maxima and minima. However, this embodiment may also be implemented in cases where subspaces consist of arbitrary sets of cuboidal subspaces and where the Dimensions may or may not be ordered.

The Address table, as shown below in Table 5, describes the place of each Descriptor in the n-dimensional space and those Primitives which represent a particular Descriptor. Note, for nonordered Dimensions, one record is needed for each Descriptor-Primitive pair. The Address table is represented in FIG. 9 by the Address block 910.

TABLE 5

| Column | Type | Description | Example |
|---|---|---|---|
| Dimension | integer | Pointer to related | 17 |
| | | Dimensions record | (= Dominant L-axis) |
| Descriptor | integer | Pointer to related | 5192 |
| | | Descriptor record | (= Bordeaux Red) |
| Low value | float | The lowest value on | 30 |
| | | the dimension for | |
| | | this Descriptor | |
| High value | float | The highest value on | 40 |
| | | the dimension for | |
| | | this Descriptor | |

The Conclusions table, as shown below in Table 6, and as represented as the Conclusions block 916 (FIG. 9) links objects directly to Descriptors. In this embodiment, Descriptors are considered transient objects. As such, when classifying an object by selecting Descriptors, the sub-spaces corresponding to the Descriptors are preferably stored as the classification of the object. The Descriptors are considered mere labels for the particular subspaces. However, since a user is likely to want to search by Descriptors, rather than by Primitives, the present embodiment stores links between objects and Descriptors for as long as the Descriptor remains valid and as long as an address associated with the Descriptor does not change.

TABLE 6

| Column | Type | Description | Example |
|---|---|---|---|
| Object | integer | Pointer to related | 87 |
| | | Objects record | (= object X) |
| Descriptor | integer | Pointer to related | 5192 = |
| | | Descriptors record | Bordeaux Red) |
| Intensity | float | Percentage to which | 0.75 |
| | | the object is | (= 75%) |
| | | accurately described | |
| | | by the Descriptor | |

Additionally, the Conclusions table may be formed by an expert opinion (i.e., 75% of object X is Bordeaux Red) or based upon deriving the value from the facts, via the Addresses. For example, all of the measured CIELAB values of an object fall within the tolerance of the color called Bordeaux Red and the proportion of this color in the object is 75%. Further, it is to be appreciated that the “intensity” of a color or of any Descriptor is just another Dimension in the space for a particular Strand. Its minimum is 0% and its maximum is 100% and may be considered continuous or discrete, depending on the possible measurements. For example, because of its subjective nature, the intensity Dimension of the Design Strand should be discrete and its Primitives should be 0%, 10%, 20%, . . . , 100%. On the other hand, the Color Strand can use objective measurements and so its intensity dimension could be continuous, i.e., it may contain real values from 0% to 100%.

Additionally, when generating a Conclusions table 916 (for example, for a Color Strand), in order to accelerate the process, the present invention preferably attempts to store classifications of colors as descriptors. For example, suppose that a color “Bright Pink” is specified by a user on a Color palette and that Bright Pink has the CIELAB values of: L=58.3, a=89.5, b=−35, and the tolerance is set to 4 by the palette designer. The present invention preferably represents the toleranced subspace of Bright Pink as a cube whose center is the lab value and whose sides are each 8 units long (4 units from the center point to each face). Additionally, this subspace contains the dominant lab color of the fabric F. Based upon this information, the system creates a new Conclusions record by noting that the dominant color of F falls within the range specified by the tolerance of the palette for the color Bright Pink. More specifically, the present invention preferably utilizes an algorithm similar to that specified below to create the Conclusions records for the Color Strand. The algorithm is:

```
fir each palette p {
  for each color level v {
  for each lab color c = <c_L, c_a, c_b> on the palette
  let t be the tolerance for this color on the palette;
    the next three constants allow the shape of the
    coboid to be surrounding a color point. If all three
    values are 1 then the cuboid is a cube. Otherwise it
    can be stretched or shrunk in each dimension for a
    more redefined choice of color volumes.
  let k_L = 1;
  let k_a = 1;
  let k_b = 1;
  minimum_L = c_L − k_L * t;
  maximu_L = c_L + k_L * t;
  minimum_a = c_a − k_a * t;
  maximum_a = c_a + k_a * t;
  minimum_b = c_b − k_b * t;
  maximum_b = c_b + k_b * t;
  ind all Facts records x such that
    (x.Dimension = “L” &
    x.maximum >= minimum_L &
    x.minimum <= maximum_L)
    OR
    (x.Dimension = “a” &
    x.maximum >= minimum_a &
    x.minimum <= maximum_a)
    OR
    (x.Dimension '2 “b” &
    x.maximum >= minimum_b &
    x,minim <= maximum_b)
    call this set of Facts records X;
    find all those Facts records x in X such that there exists a y
    and z in X such that
    x.Dimension '2 “L” &
    y.Dimension '2 “a” &
    z.Dimension '2 “b” &
    x.Fabric = y.Fabric '2 z.Fabric
    for each such Facts record x create a Conclusions record n,
    where
    n.Fabric '2 x.Fabric;
    n.Strand = “Color”;
    // this next value is actually a pointer to a record in
    the Descriptors table
    n.Descriptor = <v,c>;
    n.Intensity '2 w.Intensity, where w is the Facts
    records such that
    w.Fabric = x.Fabric &
    w.Dimension '2 v + “intensity”
    // next Facts record
  } // next palette color
  } // next color level
} // next palette.
```

While those skilled in the art appreciate that the above algorithm is rather simplistic, it is one example of how a Conclusions Table may be generated based upon entries, by a user, specifying an object

The Cuboids table, as shown in Table 7, and as represented as the Cuboids block 918 in FIG. 9, groups facts together into “cuboids.” A cuboid can be constructed in n dimensions by giving n ranges of values, one for each of the Dimensions. The cuboid consists of all the points which lie within all these ranges. For example, the cuboid for a rectangle in 2-dimensional space, where a given range exists for the x axis and a given range exists for the y axis, includes all the points whose x and y values fall within both of these ranges. Cuboids are preferred in this data model because via cuboids it is possible to classify an object as being composed of several such volumes. If a classifier selects Victorian and Art Deco as Descriptors for a single object design then the classification of this object in the Design strand is the union of the two cuboids represented by Victorian and Art Deco.

TABLE 7

| Column | Type | Description | Example |
|---|---|---|---|
| Identifier | integer | Primary key | 101 (= Cuboid A) |
| Object | integer | Pointer to related | 87 (= object X) |
| | | objects record | |

The Descriptors table, as shown in Table 8, and as represented as the Descriptors block 914 in FIG. 9, contains hierarchies (trees) of commonly used terms in a specific industry (for example, the design industry). Descriptors are accumulated on palettes (the “right hand side” of a classification strand).

TABLE 8

| Column | Type | Description | Examples | |
|---|---|---|---|---|
| Identifier | integer | Primary key | 65 | 5192 |
| Name | string | Recognizable | Colonial | Bordeaux Red |
| | | name for the | | |
| | | Descriptor | | |
| Tolerance | float | how large a | 0 | 3.4 |
| | | subspace this | | |
| | | Descriptor | | |
| | | represents | | |
| | | (used only for | | |
| | | Color strand) | | |
| Parent | integer | Pointer to | 172 | 0 |
| | | parent record in | (= Theme) | (= noparent) |
| | | a hierarchy | | |
| Strand | integer | Pointer to | 2 | 1 |
| | | strand to which | (= Design) | (= Color) |
| | | the Descriptor | | |
| | | belongs | | |
| Image | string | path to an | ../Images/ | ../Images/ |
| | | image file | Colonial.jpg | BordeauxRed.gif |
| | | representing | | |
| | | this Descriptor | | |

The Dimensions table, as shown in Table 9, and represented as the Dimensions block 906 in FIG. 9, contains the names of various Dimensions which make up the different classification spaces.

TABLE 9

| Column | Type | Description | Examples | |
|---|---|---|---|---|
| Identifier | integer | Primary key | 82 | 700 |
| Name | string | Recognizable name | Dominant | Formality |
| | | for the dimension | L-axis | |
| Min value | float | The minimum value | 0 | 0.0 |
| | | allowed for this | | (value of |
| | | dimension | | smallest |
| | | | | Formality |
| | | | | Primitive) |
| Max value | float | The maximum value | 100 | 7.0 |
| | | allowed for this | | (value of largest |
| | | dimension | | Formality |
| | | | | Primitive) |
| Strand | integer | Pointer to strand | 1 | 2 |
| | | to which the | (= Color) | (= Design) |
| | | Descriptor belongs | | |

The Facts table, as shown in Table 10, and as represented by the Facts block 904 in FIG. 9, describes where objects belong on each relevant Dimension, based on an objective measurement (e.g., CIELAB L value of the dominant color measured between 30.6 and 35.2), or an expert opinion (“the formality of this object is between Whimsical and Casual”). Note that Facts records are grouped together into cuboids. For each cuboid there should be one Facts record per Dimension.

TABLE 10

| Column | Type | Description | Examples | |
|---|---|---|---|---|
| Cuboid | integer | Pointer to related | 101 | 6 |
| | | Cuboids record | (= Cuboid | (= Cuboid B) |
| | | | A) | |
| Dimension | integer | Pointer to related | 82 | 700 |
| | | Dimensions record | (= Dominant | (= Formality) |
| | | | L-axis) | |
| Min value | float | The minimum value | 30.6 | 4.0 |
| | | measured | | (Whimsical) |
| Max value | float | The maximum value | 5.2 | 6.0 |
| | | measured | | (Casual) |

The Palettes table, as shown in Table 11 and as represented by the Palettes block 922 in FIG. 9, contains records which describe a collection of Descriptors that can be taken from one or more Strands. A Strand may have many palettes and a palette can use many Strands.

TABLE 11

| Column | Type | Description | Example |
|---|---|---|---|
| Identifier | integer | Primary key | 940 |
| Name | string | Descriptive name | Next Year's |
| | | of the palette | Trendy Colors |
| Date | date | Date when the | Jul. 16, 2000 |
| Created | | palette was made | |
| Date | date | Date when the | 36924 |
| Modified | | palette was last | |
| | | edited | |
| Version | integer | Version number of | 4 |
| | | this palette as it | |
| | | is altered | |
| Created | string | Name of the palette | J. Smith |
| By | | designer | |

The Palettes Descriptors table, as shown in Table 12 and as represented by the Palette Descriptors block 920 in FIG. 9, contains the relations between Palettes and Descriptors. Each palette can contain many Descriptors and each Descriptor can appear on more than one palette. Note that each Descriptor preferably only belongs to a single Strand, however, the invention is not to be construed as being so limited.

TABLE 12

| Column | Type | Description | Example |
|---|---|---|---|
| Palette | integer | Pointer to a palette | 940 |
| | | | (= Next Year's |
| | | | Trendy Colors) |
| Descriptor | integer | Pointer to a Descriptor | 5192 |
| | | | (= Bordeaux Red) |

The Primitives table, as shown in Table 13 and as represented by the Primitives block 908 in FIG. 9, describes the ranges of non-numeric, discrete Dimensions.

TABLE 13

| Column | Type | Description | Example |
|---|---|---|---|
| Name | String | Descriptive name of | Shabby |
| | | the Primitive | |
| Value | Float | Order (if dimension is | 1 |
| | | a spectrum of ordered | |
| | | values) | |
| Dimension | Integer | Pointer to the | 700 |
| | | dimension the | (= Formality) |
| | | Primitive belongs to | |
| Image | String | path to an image file | ../Images/Shabby.jpg |
| | | representing this | |
| | | Primitive | |

The Strands table, as shown in Table 14 and represented by the Strands block 912 in FIG. 9, provides the different Strands used to break up the classification of an object into sensible parts. As mentioned previously, currently there are four Strands used in the fabric classification embodiment: Color, Composition, Design, and Supply.

TABLE 14

| Column | Type | Description | Example |
|---|---|---|---|
| Identifier | integer | Primary key | 1 |
| Name | string | Recognizable name | Color |
| | | for the strand | |

Upon a user inputting Descriptors, selecting Primitives from palettes, and otherwise inputting information related to a request for a specific object, the present invention preferably searches its existing databases to identify objects (previously defined by sellers) which match the user's request. More specifically, the present invention preferably utilizes a search engine to retrieve information on objects that meet the criteria specified by the user via the front-end application (i.e., the applications by which objects, Descriptors, Primitives, and the like are specified and/or selected). The design of the search engine utilized by the present invention is preferably specified such that it is compatible with the before mentioned object classification scheme and, for purposes of this specification, shall be so described. However, it is to be appreciated that the search engine may be designed to be compatible with any classification scheme, including ones for objects, designs in general (for example, graphic designs and architectural designs), and any other database in which objects or concepts are generally not precisely defined (i.e., objects or concepts where definitions and other Descriptors may vary based upon physical, functional, temporal, or other parameters).

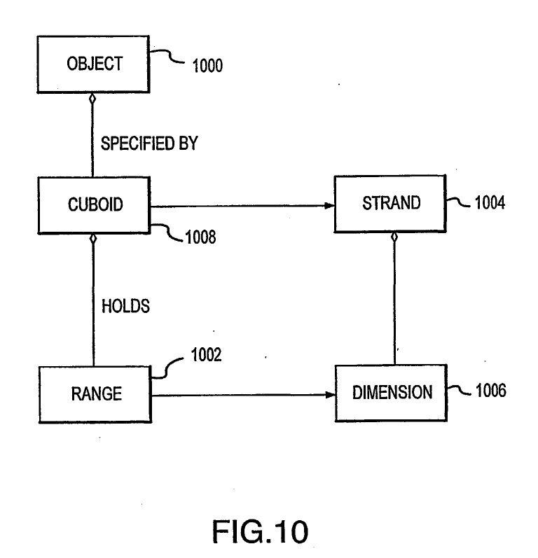

For the preferred embodiment, the search engine is utilized in conjunction with a classification scheme which designates a place in an N-dimensional space for each object. These Dimensions are the characteristics that can be attributed to any object, such as primary color, depiction, lightness, etc. As discussed previously, these individual Dimensions are preferably grouped in one of three Strands: color, composition, and design. With the fourth Strand, supply, merely providing purchasing information after an object has been identified and selected. Further, each of these Strands is associated with its own Dimensions, such that the characteristics of an object for each Strand can be modeled as a set of one or more cuboids. FIG. 10 illustrates the associations, as previously described above, between Strands, objects, cuboids, ranges, and Dimensions.

When a user initiates a search for objects by specifying criteria that a particular object must meet, the system preferably creates an area for each Dimension called a SearchSpace (i.e., a collection of cuboids that represent the conditions that an object (which can be defined by a collection of cuboids) must meet in order to be selected in a search). The system also creates a SearchGroup which encompasses each of the SearchSpaces and a result set which contains objects, whose place in N-space overlap on more than one of the SearchSpaces in the SearchGroup. Since a search generally comprises one or more SearchSpaces and a collection of SearchSpaces is called a SearchGroup, the present invention suitably utilizes the logical operations (OR and AND) to merge two single SearchGroups into a combined SearchGroup. For example, a search is defined in terms of four Cuboids:

A: {plain, informal, mini, busy, 1920};

B: {Neutral, informal, mini, busy, 1920};

C: Victorian; and

D: Neo-Classical.

As such, the Cuboids are basically requests to the system to find those objects that satisfy (A OR B) AND C OR D). Additionally, the system preferably combines the SearchGroups as follows:

SearchGroup 1: SG1 is formed by the operation A OR B. The result is {A, B}; and

SearchGroup 2: SG2 is formed by the operation C OR D. The Result is {C, D}.

The final combined SearchGroup is formed by the operation AND(SG1, SG2). Which results in the following four groups: {A,C}, {A,D}, {B,C}, {B,D}, which are: (1) plain, informal, mini, busy, 1920, Victorian; (2) plain, informal, mini, busy, 1920, Neo-Classical; (3) neutral, informal, mini, busy, 1920, Victorian; and (4) neutral, informal, mini, busy, 1920, Neo-Classical.

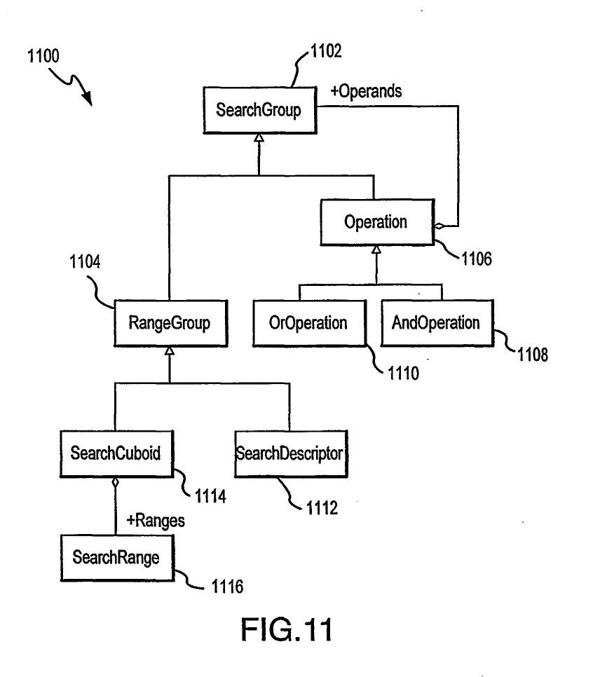

Once the search is defined in terms of at least one SearchGroup, the system offers a SearchGroup object to the search-engine (preferably a software algorithm operated by the controller 16) in a structure 1100 as shown in FIG. 11. The search engine utilizes this structure as a basis for finding the objects that satisfy the given criteria. Since information on the objects is preferably stored in a relational database, the controller 16 searches for objects that match specified criteria by utilizing a combination of set operations, as is commonly known in the art In order to search for an object, the controller/search engine first transforms the search criteria specified in the SearchGroup into a table structure that can be processed by the relational database management system. More specifically, the table preferably identifies those SearchSpaces, cuboids in the SearchSpaces, and the range values and associated Dimensions in the cuboids. Since several searches might take place simultaneously, each SearchGoup is issued a unique SearchID. Table 15 provides an illustrative example of a search table.

TABLE 15

| SearchGroup | Description |
|---|---|
| SearchID | An identifier for the search |
| SearchSpaceID | An identifier for the search space |
| CuboidID | An identifier for the search cuboid |
| DimensionID | An identifier for the dimension |
| HighVal | The highest value in the range |
| LowVal | The lowest value in the range |

The search engine retrieves the objects that meet the criteria by utilizing a combination of SQL statements, which are preferably implemented as parameterized views.

More specifically, the system is designed around a set of predetermined goals, for example, the goal of finding objects that meet the criteria specified by the user. In order to reach this goal, the system provides the necessary functionalities, such as the ability to define a new search, interpret search criteria, search for objects, and present objects to the user. To provide these functionalities, the system utilizes a SearchEngine object (the use of objects in relational databases is well known in the art and is not discussed further herein). The controller interfaces with the SearchEngine object preferably by utilizing the following coding:

SearchEngine.SearchObjects (SG: SearchGroup): SearchResult.

Upon entry of this coding in the relational database management system, the following preferably occurs: (1) a database connection is established; (2) the system then designates a Searchid; (3) at least one SearchGroup is converted into a table structure (as discussed previously); (4) queries are executed for getting the requested data; (5) the system Converts the query into a SearchResult object; (6) then the system removes the SearchGroup data from the table; (7) the connection to the database is closed; and (8) the results of the search are returned to the user.

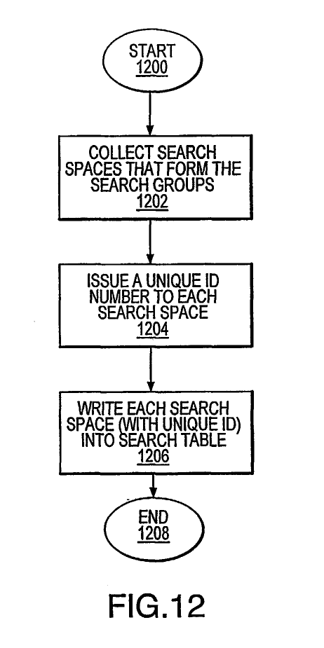

As mentioned previously, the present invention preferably utilizes a SearchSpace table to retrieve objects from the relational database management system which satisfy the user's request. In order to develop the search table, the system preferably utilizes the Build Search Table method, as shown in FIG. 12. As shown, the Build Search Table method preferably begins with collecting the SearchSpaces that form the SearchGroups (as discussed previously, herein) (Block 1202). The collecting of the SearchSpaces may be a complex activity or a rather simple activity, depending upon the complexity of the objects being searched. After the SearchSpaces are collected, these are then issued a unique identification number which is suitably utilized by the system to track the SearchSpaces and associate search results therewith (Block 1204). The SearchSpace is then written with the unique ID into the search table (for example, as shown in Table 15) (Block 1206).

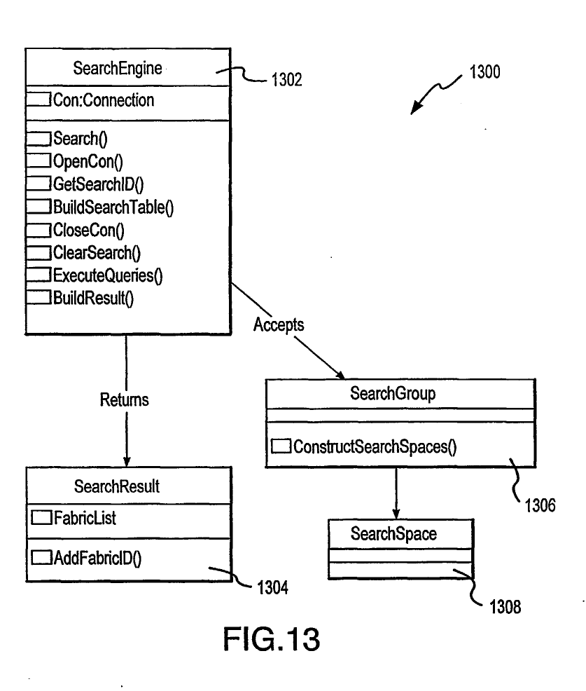

FIG. 13 illustrates the relationship between the search engine and a SearchSpace for the present invention. As shown, the search engine 1302 accepts a SearchGroup object 1306 as a search criteria, fills the search table, executes the query, and returns the SearchResult 1304. Further, the SearchGroup object 1306 represents one or more SearchSpaces 1308 which are suitably derived from the subelements from which the SearchGroup is constructed.

As discussed previously, a SearchSpace is a derived object and a set of SearchSpace objects define a SearchGroup. Since SearchSpace objects generally consist of a set of value ranges, which are grouped together in range groups, a group of value ranges can be user determined (cuboids) or predetermined (named Descriptors). When a SearchSpace consists of more than one RangeGroup, the cuboids of the object must overlap each of these RangeGroups in order to satisfy the search criteria.

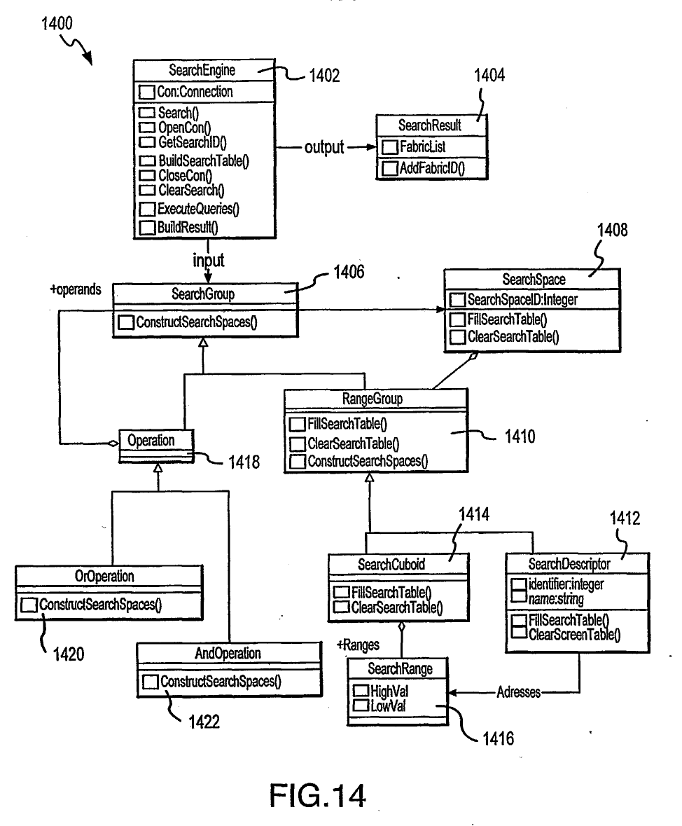

FIG. 14 illustrates one embodiment of a structural design of a search engine 1400 based upon the foregoing descriptions. As shown, the search engine 1400 preferably includes a SearchEngine 1402, which (upon establishing a connection and receiving a request) generates a search, builds a search table, exits queries, builds results, and outputs the SearchResult 1404 to a user. As mentioned previously, the SearchEngine 1402 receives inputs from a SearchGroup 1406 which suitably constructs SearchSpaces 1408 based upon entries in a search table. Additionally, the SearchSpace 1408 utilizes RangeGroups 1410 to determine which values to place in the SearchTable. Similarly, the RangeGroups 1410 receive information from SearchCuboids 1414 which include additional search ranges 1416 and SearchDescriptors 1412. Lastly, the SearchGroup 1406 may be configured, as particular searches require, to combine various other searches by performing logical Operations 1418 such as OrOperations 1420 and/or AndOperations 1422. As such, the structure of the search engine 1400 preferably resembles the structure by which data is entered into the system to define object requests and to identify objects.

Additionally, in conducting the identification search, the controller 16 (FIG. 2) can use various different types of comparison. Preferably, these are selectable by the user. They may also be selected individually for different Dimensions. In particular, the controller 16 can look for a direct match between the Primitives defining the Descriptors and the Primitives defining the objects. Alternatively, the controller 16 could look for objects having Primitives within the ranges defined for the Descriptors or overlapping with the ranges defined for the Descriptors.

Thus, according to the described system, a user may search for a particular type of object using Descriptors by which the objects themselves are not defined. New Descriptors may be defined according to changes in fashion. For instance, a classification palette may include fashionable colors for a season or new terms in the trade may be introduced. Despite this, the object records may be used indefinitely without need for modification. The user may also define custom Descriptors according to the user's own needs. By providing the definition of the Descriptors as classification spaces having Dimensions for the various properties of the classification space, the user can easily change the definition of a Descriptor without the need for a particular textual definition.

Since the system provides a quantitative definition of the subjective Descriptors, it also becomes possible to monitor quantitatively the types of object for which users are looking. This information may be used by suppliers to provide objects according to demand.

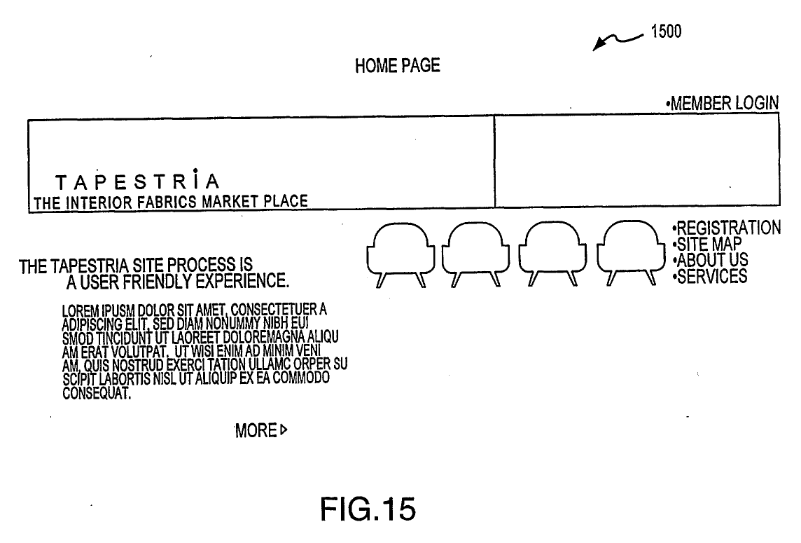

Referring now to FIG. 15, one embodiment of a system implementing the features and functions of the present invention is depicted for a fabrics embodiment. In this embodiment, the present invention is hosted by an Internet Service Provider which is contacted by users via an Internet connection. As shown on the Home page 1500, this embodiment requires a user to register as a member prior to gaining access to the features and functions provided therewith. However, the present invention is not to be construed as requiring users to register before use is permitted and may be utilized in an embodiment where a user's identity remains anonymous. Additionally, this embodiment preferably uses a username and password to identify user members. However, other recognition schemes such as audio and visual identifiers, coded representations and other information may be utilized.

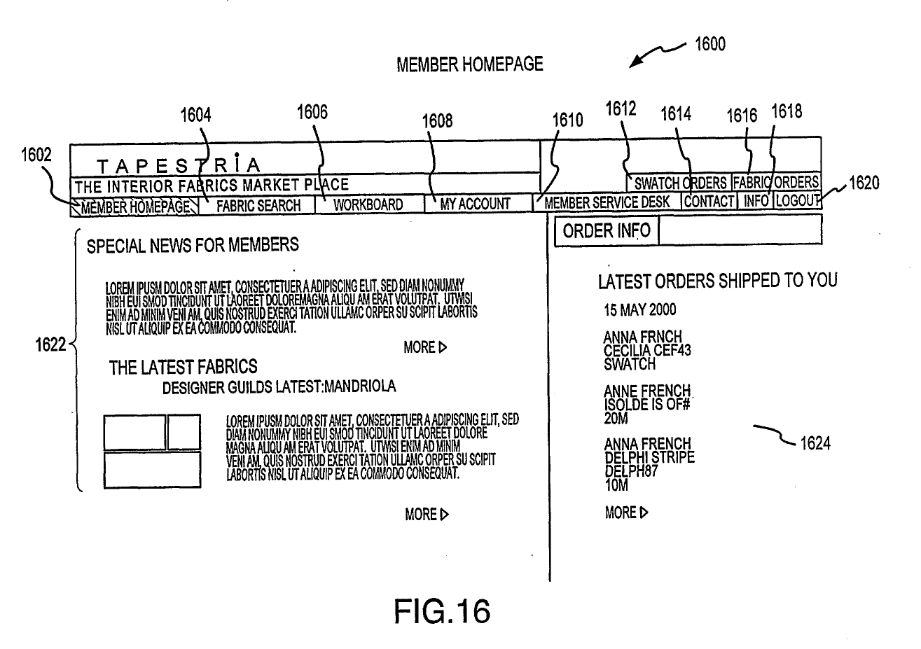

Upon logging onto the Internet site, the embodiment then provides the Member with a customized Member Home page 1600, as shown in FIG. 16. At this point, the embodiment suitably presents Special News for Members or other similar information in a first data field 1622 while presenting Order Info in a second data field 1624. Thus, in addition to providing search and identification capabilities, the fabrics embodiment also provides back-end accounting and order management capabilities, such capabilities are well known in the art. Further, this embodiment provides a user with a menu bar of selections. For example, the user may return (from any other page on the system) to the member Home page by selecting button 1602. Similarly, the Fabric Search button 1604 initiates fabrics searches. The Workboard button 1608 enables a user to review various aspects of a search and results returned thereto (the Workboard function is explained below in greater detail). A user may edit account information by selecting the My Account button 1608, or may submit queries to member services via the Member Services Desk button 1610. Additionally, the Swatch Orders button 1612, Fabric Orders button 1616, Contact button 1614, Info button 1618, and Logout buttons 1620 provide various self-explanatory functions.

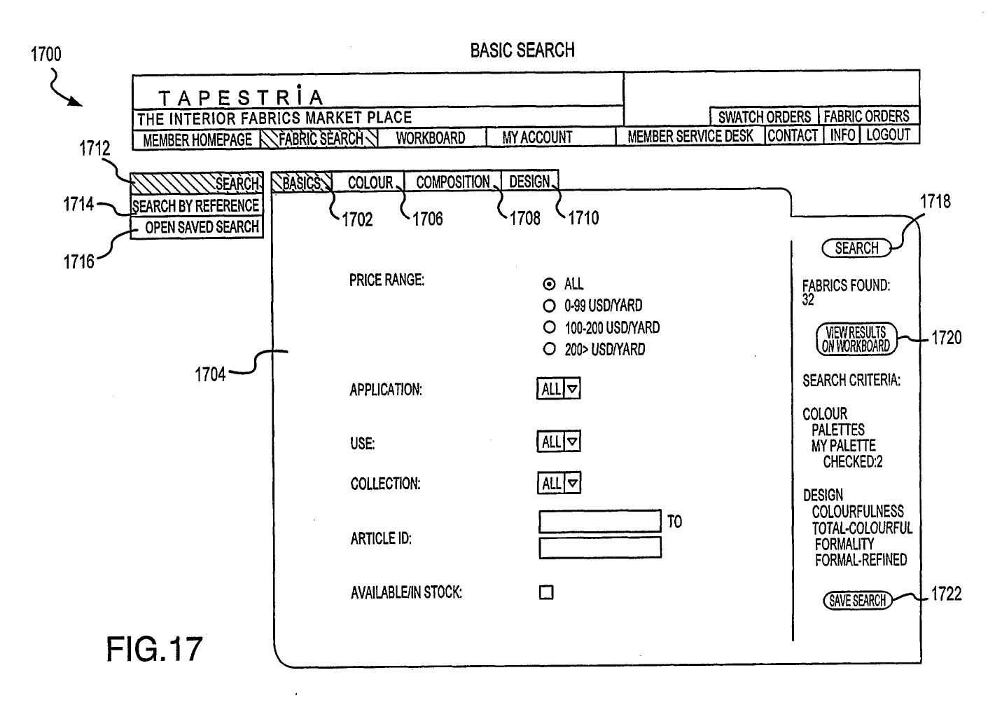

When the Fabric Search button 1604 is selected, the system preferably displays the Basic Search page 1700, as shown in FIG. 17. This page 1700 allows a user to specify various parameters for a fabric search in a Basics field 1704 when the Basics tab 1702 is selected. These parameters include a price, application, use, collection, Article Ids, and number available in stock. When the Search tab 1712 or Search button 1718 is selected, the system suitably identifies those fabrics meeting the input parameters and provides an indication of the number of results.

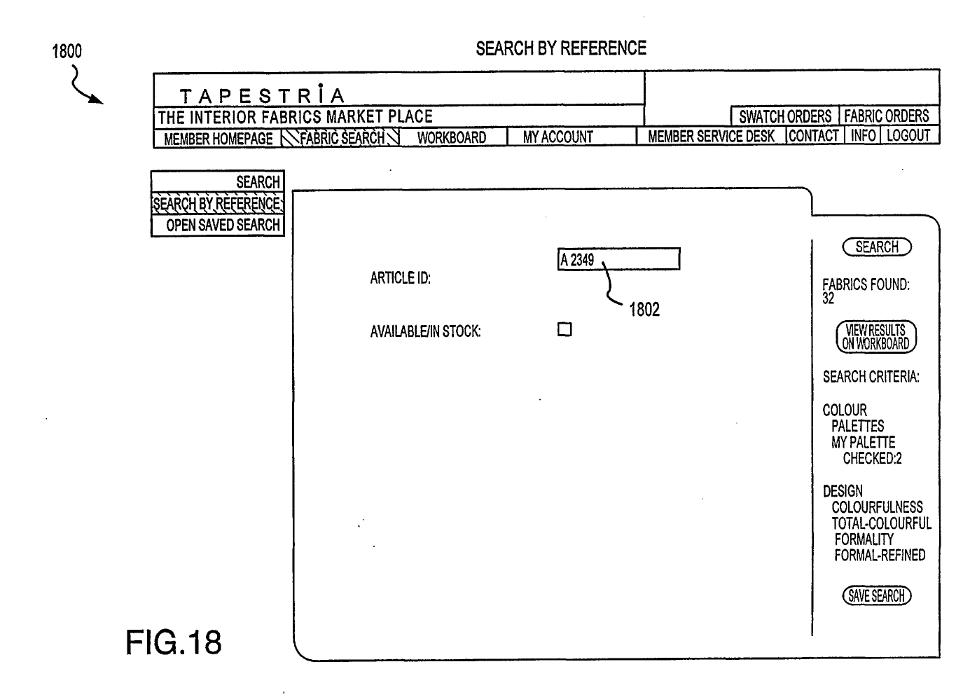

Further, when the Search by Reference tab 1714 is selected, this embodiment suitably displays the Search by Reference page 1800, as shown in FIG. 18. This page 1800 allows a user to input an identifier into an Article Id field 1802 and then conduct searches for those fabrics matching the entered identifier.

Referring again to FIG. 17, this embodiment also allows a user to Open Save Search by selecting the tab 1716, View Results on a Workboard by selecting button 1720, and to Save Search via button 1722. Further, search terms may be specified by selecting one of the three displayed Strands (Color, Composition, and Design) via the corresponding tabs 1706, 1708, and 1710, respectively.

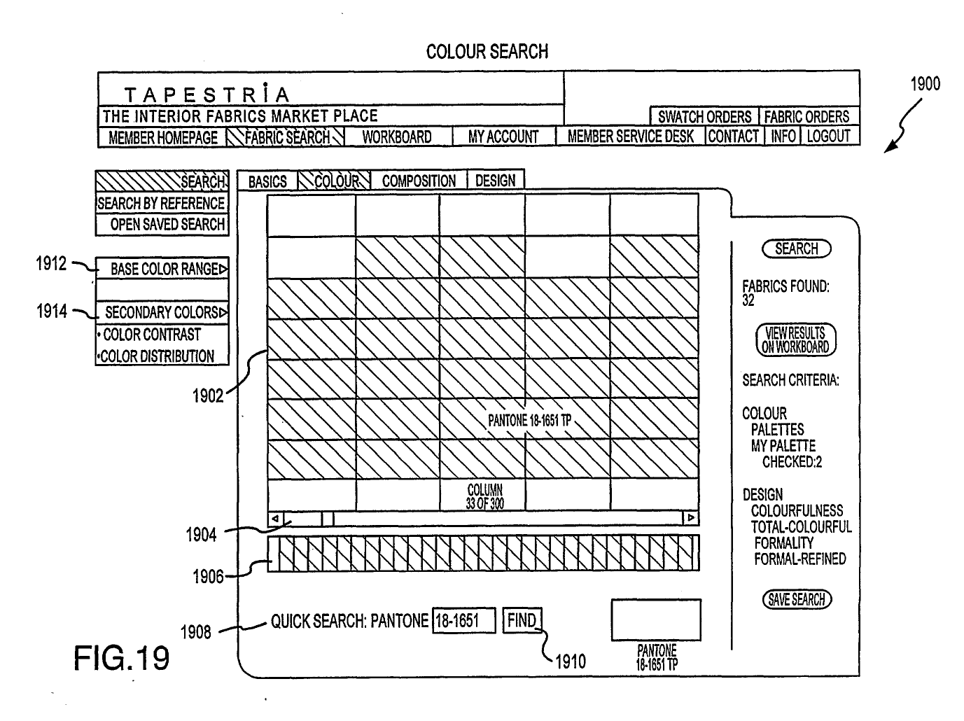

When the Color tab 1706 is selected, the system displays the Color Search page 1900, as shown in FIG. 19. This page 1900 allows the user to select a desired color via various approaches. One approach for selecting the color involves selecting a color from a table of color chips 1902. The selections of color on the color chip may be modified by utilizing the scroll bar 1904, or selecting a chip on the chip bar 1904. Additionally, when a name for a color is known, the user may input such color name into the QuickSearch field 1908 and selecting the Find button 1910. The system preferably displays the selected color in the bottom right portion of the screen display. Additionally, tab fields exist which allow a user to select a Base Color Range 1912 or the Secondary Colors 1914. The system defaults to the user specifying the primary color first, however, any order for entering and specifying colors may be utilized.

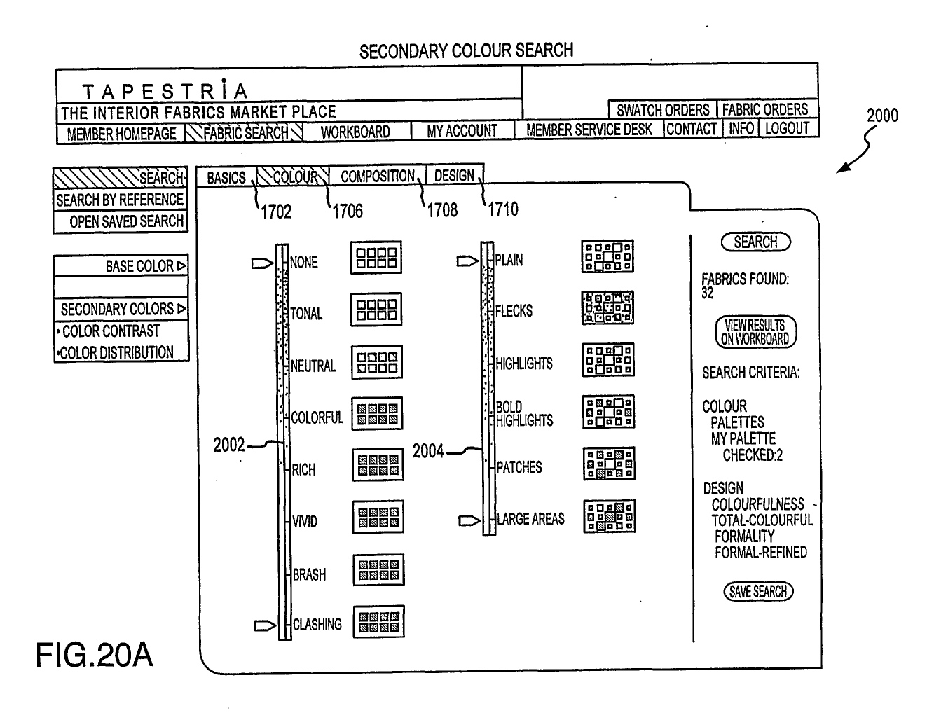

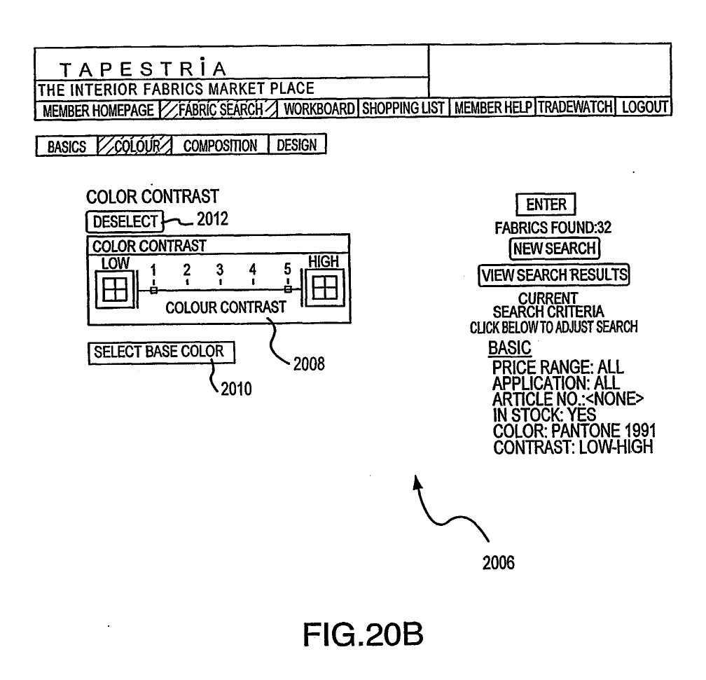

Upon selecting the Secondary Colors tab 1914, the system then preferably displays the Secondary Color Search page 2000, as shown in FIG. 20A. This page 2000 preferably provides the user with choices for identifying how the secondary color appears in relation to the primary color. As shown, the user may select from a varying range of color contrasts 2002 and from varying ranges of color distribution 2004.

Additionally, this embodiment allows a user to use a scroll bar 2008 which suitably varies the contrast between a primary color and a highlight color, as shown in FIG. 20B. The scroll bar 2008 suitably allows the user to change the contrast between a base color, which is selected via the Select Base Color buttons 2010, and the highlight color. The Deselect button 2012 suitably enables the user to deselect colors.

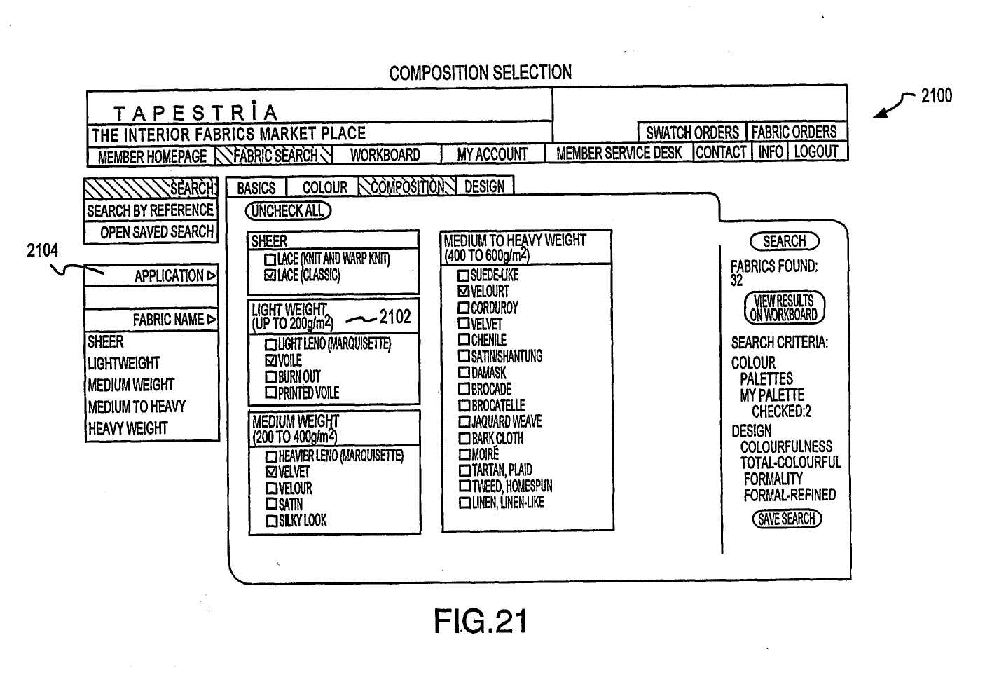

When the user selects the Composition tab 1708, the system displays the Composition Selection page 2100, as shown in FIG. 21. This page 2100 provides the user, in field 2102, with various check boxes which the user may select, as desired, to specify a specific type of composition for the desired fabric. Those skilled in the art appreciate that any number of fields and/or check boxes may be utilized, as desired, to identify a specific request. The present embodiment is not to be construed as being limited to searches for only fabrics, specific fields, or specific check boxes and may be modified as desired for a particular use or type of fabric identification.

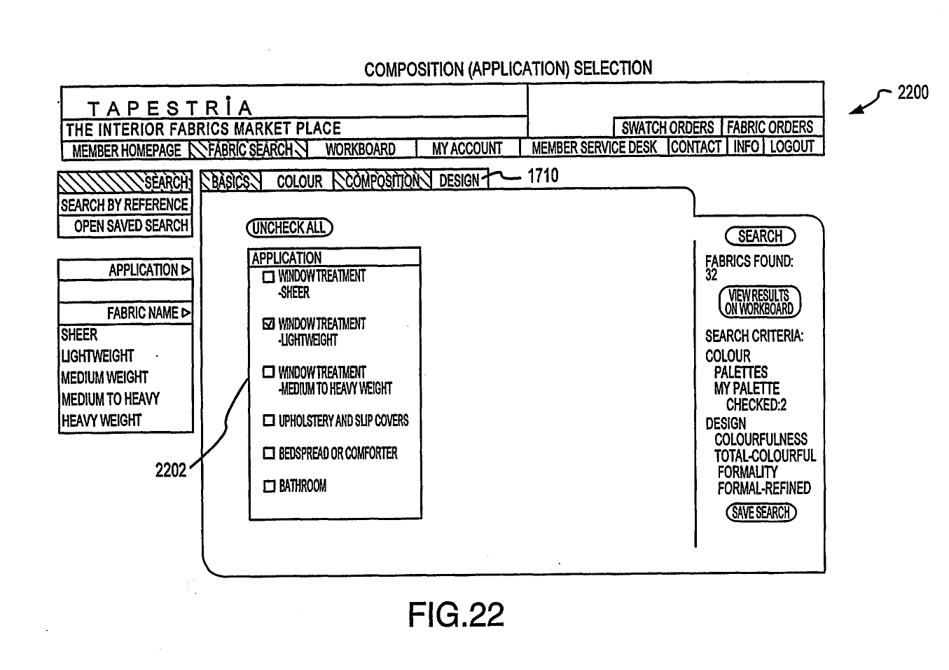

When the user selects the Application tab 2104, the system displays the Composition (application) selection page 2200, as shown in FIG. 22. As shown, the system suitably displays in field 2202 a usage for a fabric in a home decorating environment. Other fields and uses may be specified, as desired, without departing from the spirit and scope of the present invention.

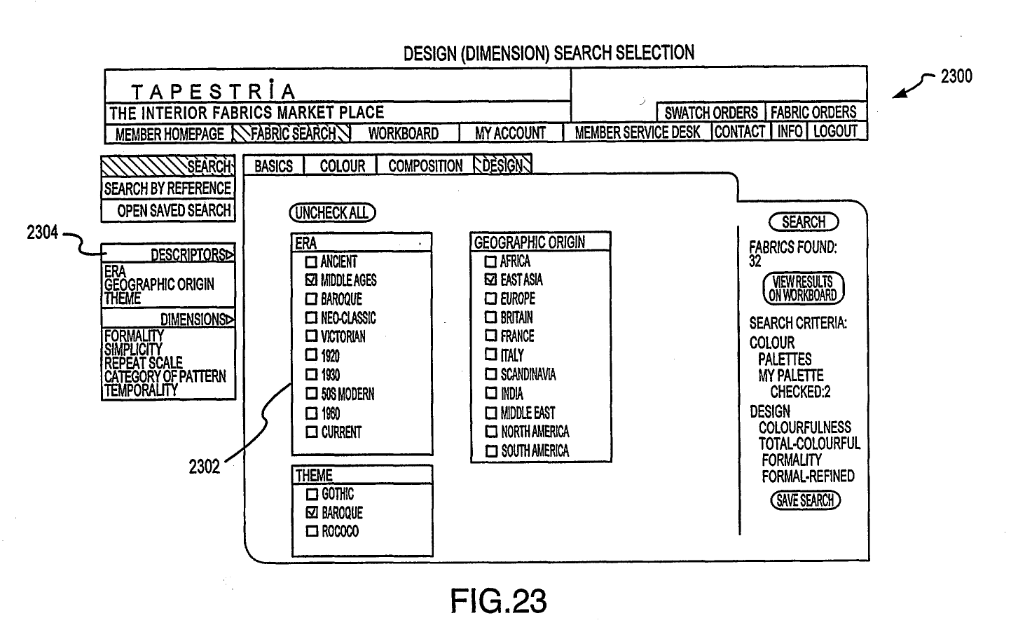

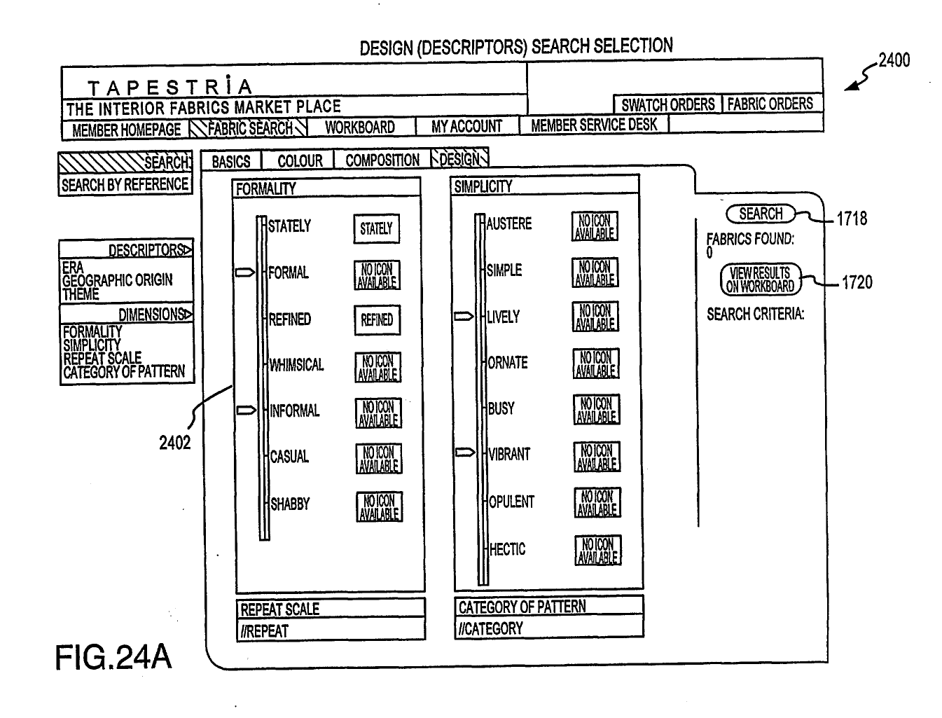

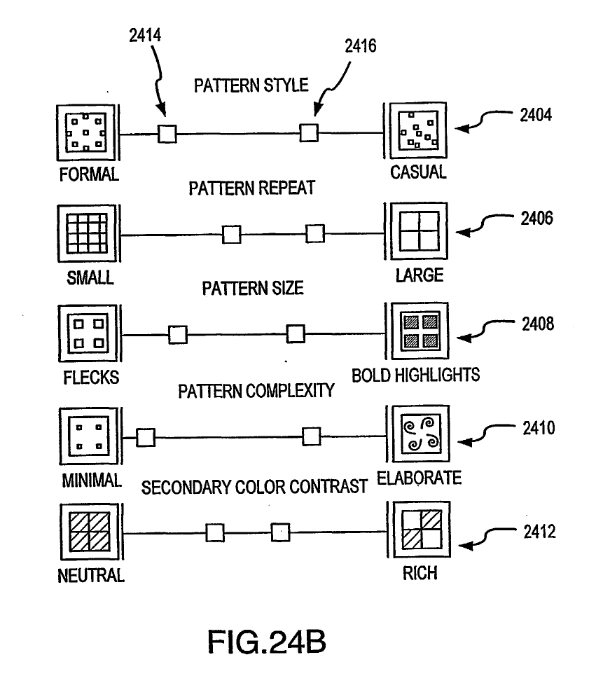

When the Design tab 1710 is selected, the system displays the Design (dimension) search selection page 2300, as shown in FIG. 23. As for the previous pages, this page 2300 also provides a field 2302 in which a user may further specify design characteristics desired for a given fabric. When the Descriptors field 2304 is selected, the system displays the Design (Descriptors) search selection page 2400, as shown in FIG. 24A. This page 2400 also provides a field 2402 in which the user may select, designate, and/or identify characteristics for a given fabric, or a range of characteristics for a fabric. Further, as shown in FIG. 24B, the present embodiment may also be configured such that a plurality of sliders are provided which assist the user in further defining a search for fabrics. For example, sliders for pattern style 2404, pattern repeat 2406, pattern size 2408, pattern complexity 2410, and secondary color contrast 2412 are shown. Additionally, high and low values range for each of these colors may be set via buttons 2414 and 2416, respectively.

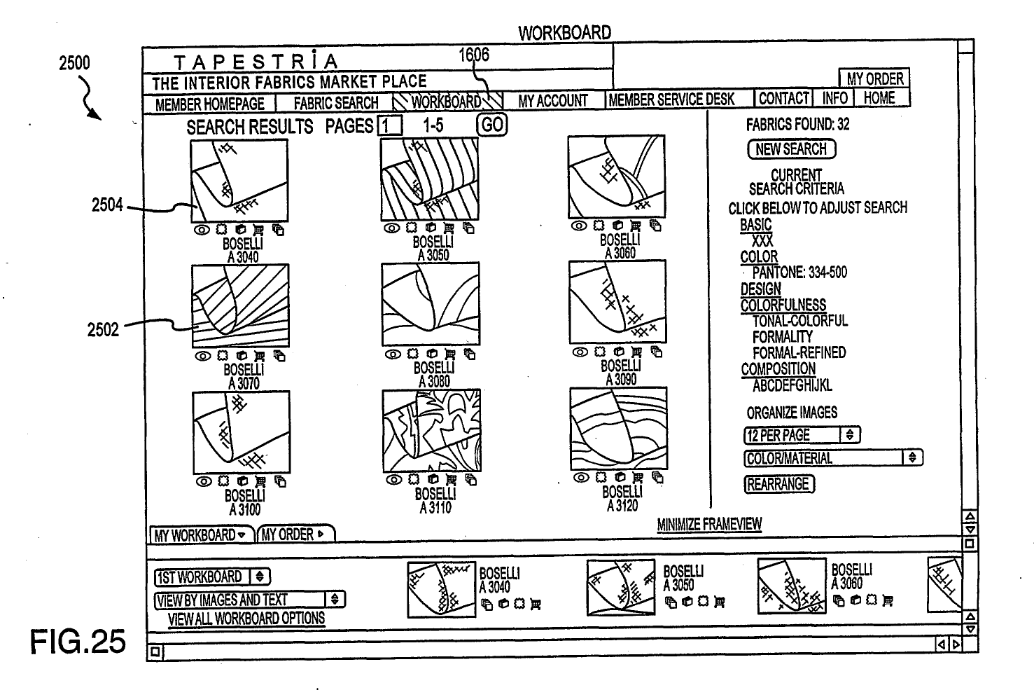

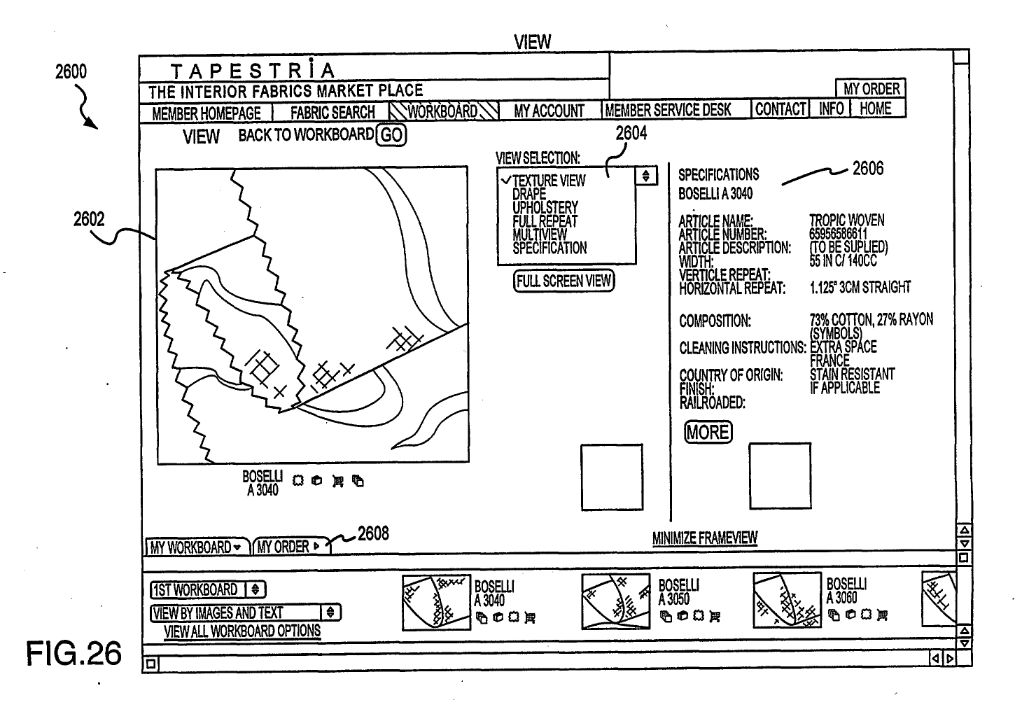

FIG. 25 provides an illustration of the Workboard page 2500 presented by this embodiment when the user selects either the View Results on Workboard button 1720 (see FIG. 24A) or the Workboard tab 1606. As shown in FIG. 25, this page 2500 returns results of searches based upon the criteria previously input by the user. The Workboard feature may preferably be selected at any stage of the request process, with varying levels of sophistication and screening occurring as more parameters are input on the various before mentioned pages. Additionally, the present embodiment provides all of those functions normally associated with Internet-based applications including the capabilities of selecting items for cutting, copying, pasting, enlarging, forwarding to others, etc. Additionally, when a user selects an image presented in the Workboard field 2502, for example, the Boselli image 2504, the system preferably provides a View page 2600 associated with the item selected, as shown in FIG. 26.

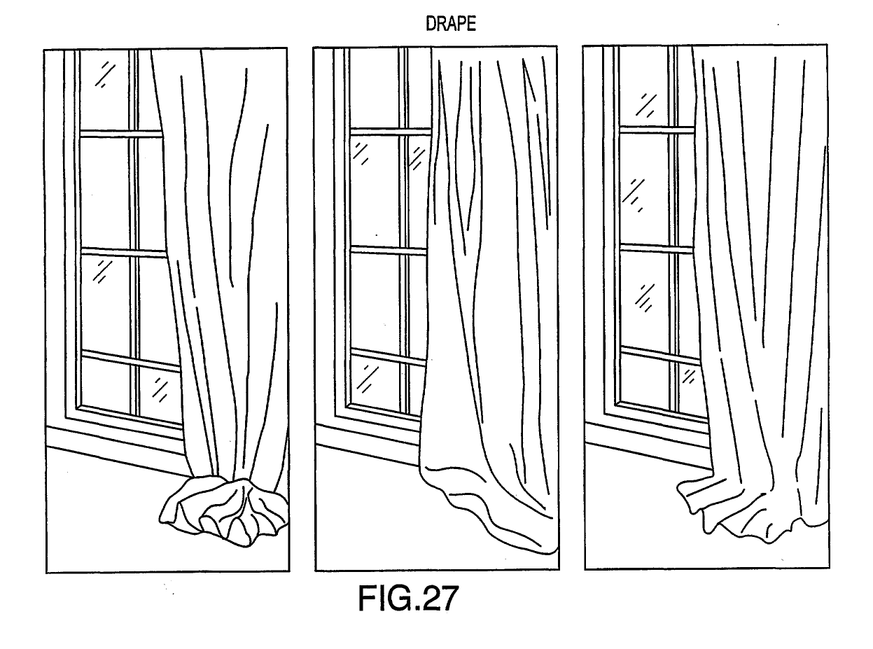

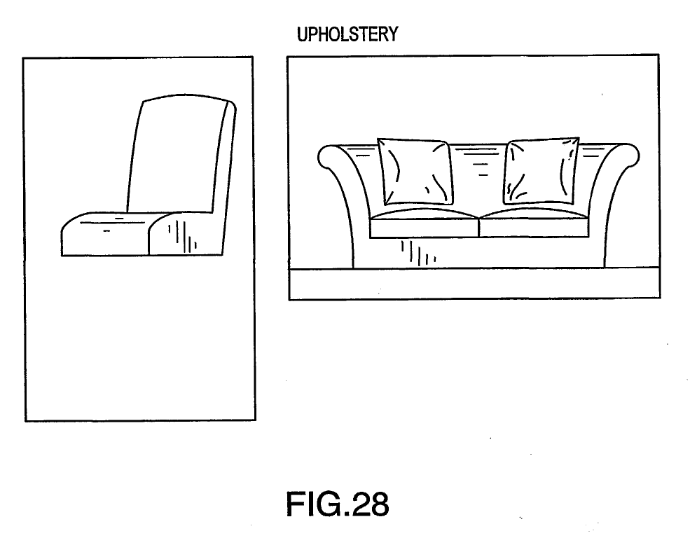

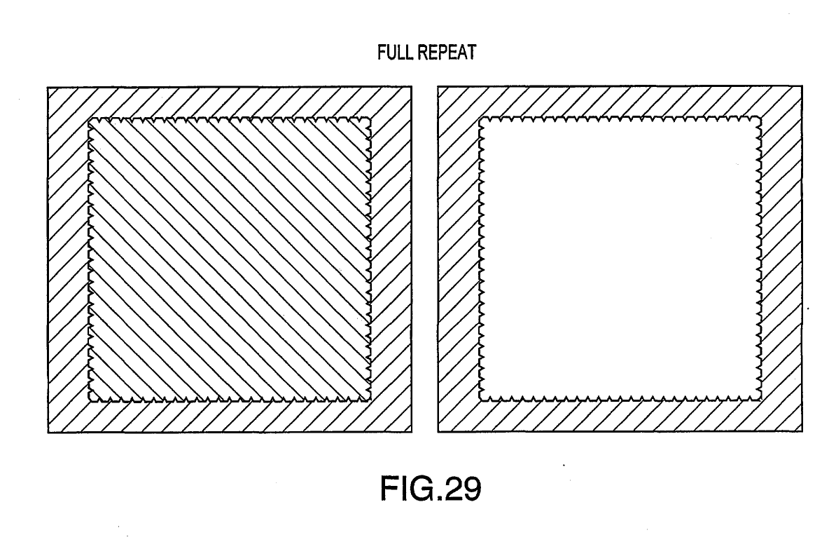

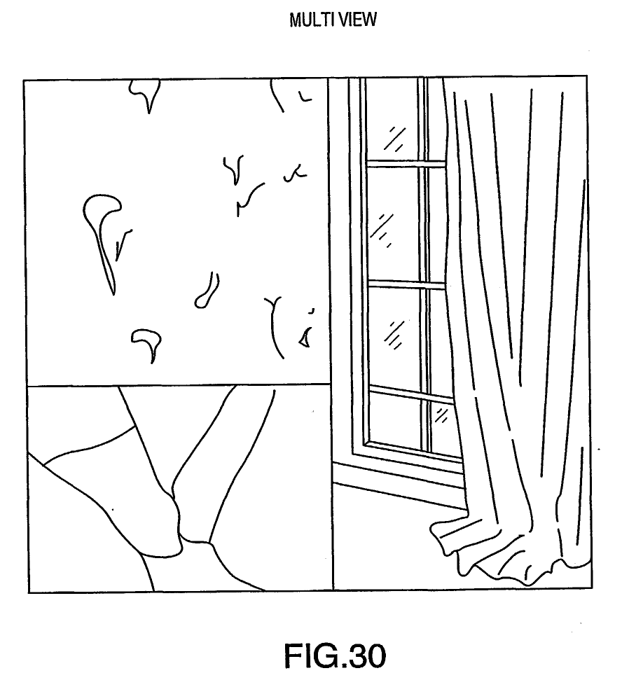

In addition to providing a field 2606 in which the specifications for the selected fabric are provided and a field 2602 in which an enlarged view of the fabric is provided, the system also provides the user with a selection box 2604 from which various views may be selected. Since this embodiment specifically pertains to tapestries commonly utilized for window coverings, the views provided are directed thereto. However, it is to be appreciated that other views may be generated or made available as specific needs dictate. FIGS. 27-30 show the various additional views selectable for this specific application of the present invention, that is FIG. 27 shows a Drape view, FIG. 28 shows an Upholstery view, FIG. 29 shows a Full Repeat view, and FIG. 30 shows a Multiview view. Lastly, by selecting the My Order button 2608, the user is provided with online ordering features, which are well-known in the art and are not discussed further herein.

As such, the present invention provides a system and method for identifying objects. While the present invention has been described in the context of various data structures, search engines, and Internet applications, it is to be appreciated that the present invention is not to be construed as being limited to those systems and methods identified herein and may be modified, added to, or deleted from, as necessary, to encompass the spirit and scope of the present invention.

TABLE 1
DIMENSIONS AND DESCRIPTORS FOR DESIGN STRAND

| DIMENSIONS | DESCRIPTORS |
|---|---|
| Category of Pattern (Major groups | ERA (Historical period evoked by |
| of design): Animal; Figure; Floral; | a design): Ancient; Pre-Christian; |
| Geometric; Novelty; Ornament; | Greco-Roman; Middle Ages; |
| Scenic | Renaissance; Elizabethan; |
| Colorfulness (How colors react in | Neo-Classical; Colonial; Victorian; |
| design): Plain; Tonal; Neutral; | 1920; 1930/1940; Modern; 1960; |
| Colorful; Rich; Vivid; Brash; | 1970; 1980; 1990; 2000+ |
| Clashing | Ethnic Origin (Geographical origin |
| Depiction (Appearance of a design): | evoked by design): Africa; Egypt; |
| Fantasy; Photographic; Realistic; | Asia; Central Asia; East Asia; |
| Tromp L'Oeil; Graphic; Stylized; | Japan; South Asia; India; |
| Abstract; Textured; Digital | Central & South America; Europe; |
| Formality (Formality of a design): | Eastern Europe; Russia; Northern |
| Stately; Formal; Refined; Whimsical; | Europe; Britain; Scandinavia; |
| Informal; Casual; Shabby | Southern Europe; France; Italy; |
| Lightness (Measure of lightness of | North America |
| design): Pale; Pastel; Bright; | Theme (Standard design themes): |
| Subdued; Greyed; Aged; Dull; Dark | Coptic; Gothic; Gothic Revival; |
| Locale (How urban or rural is | Baroque; Rococo; Chinoiserie; |
| design): Metropolitan; Urban; | Colonial; Arts and Crafts; |
| Suburban; Country; Rural; Nomadic; | Art Nouveau; Bauhaus; |
| Isolated | Constructivism; Modern; French |
| Repeat Structure (Physical | Provincial; Country; Ethnic; |
| construction of repeat): Side- | Tropical; Animal Prints (safari) |
| by-side; Half over, Half Drop | Trend (Current or fashionable |
| Pattern Type (Resulting | design themes): Neo Traditional; |
| Appearance of Repeat): All over; | Geometrics; Anti-Symmetry; |
| Grid; Brick; Shell; Ogee; | Digital; Country; Asian |
| Diamond; Trail; Single Motif; | |
| Panel; Border | |
| Scale (Measure of size of repeat): | |
| Micro; Mini; Small; Medium; | |
| Large; Over scale | |
| Density (Measure density of | |
| repeated design): Open; Spacious; | |
| Spot; Medium; Dense Packed | |
| Simplicity (Measure of complexity of | |
| design): Austere; Simple; Lively; | |
| Ornate; Busy; Vibrant; Opulent; | |
| Hectic | |
| Strength (Measure of fragility of | |
| a design): Light; Delicate; Intricate; | |
| Animated; Energetic; Robust; Strong; | |
| Monumental | |
| Temporality (Measure of historical | |
| period of design): Ancient; | |
| Pre-Christian; Greco-Roman; Middle | |
| Ages; Renaissance; Elizabethan; | |
| Neo-Classical; Colonial; Victorian; | |
| 1920; 1930/1940; Modern; 1960; | |
| 1970; 1980; 1990; 2000+ | |
| Texture (Measure of surface texture | |
| appearance): Matte; Faded; Wash; | |
| Painterly; Stipple; Splatter; Faux; | |
| Line; Shiny; Metallic; Loft | |

TABLE 2
DESCRIPTORS FOR SUPPLY STRAND
DESCRIPTORS

Article Number and Description: Generally a supplier specific identifier of
a fabric
Range Name: Range from which the fabric is taken
Supplier: name or identifier of supplier of fabric
Price: per meter or yard
Price Range: the relative price of a fabric (e.g., low, medium, or high)
Stepped Price List: price based upon length of fabric
Length Available: how many meters/yards of fabric are available for
purchase
Roll Length: the number of meters/yards on a roll of fabric
Color Ways: other color ways in the same range
Linked Coordinates: other fabrics designed to match with a fabric
Regions Served: regions or countries in which a fabric is available
Delayed Delivery Time: time taken to deliver a fabric when there are
unusual circumstances
Newness: how long a fabric has been in the system so that “Hot” or
“New” fabrics can be displayed
Special Promotion: supplier's text which is used to modify the fabric's
descriptions, e.g., discounts

TABLE 3

| | Primitives | | | |
|---|---|---|---|---|
| | | Yarn | Yarn Type | Fibre base |
| Dimensions | Threads/ | Count | Filament/ | material in % of |
| Component | cm | (D)Tex | Spun/Fancy | total fabric weight |
| Warp | | | | |
| Weft | | | | |
| Pile | | | | |
| Construction | Dobby | Jacquard | Single Fabric | Double fabric |
| | Woven | Woven | | |
| Plain | | | | |
| Panama | | | | |
| Twill | | | | |
| Satin | | | | |
| Crèpe | | | | |
| Leno | | | | |
| | Plain | Jacquard | | |
| | Knitted | Knitted | | |
| Tricot | | | | |
| Raschel | | | | |
| Rasch + Weft | | | | |

| | | | |
|---|---|---|---|
| | Non-Woven | Layer | N-layers |
| Spun-bond | | | N= |
| Thermo-bond | | | N= |
| Chem-bond | | | N= |
| | Other technique | | |
| Finishing | Base Method | Base | Type of Dyestuff |
| | | Chemical | |
| Fiber-dyed | | | |
| Yard-dyed | | | |
| Piece-dyed | | | |
| Printed | | | |
| Coated | | | |
| Padded | | | |
| Width | | Thickness | Total Weight |

| | | |
|---|---|---|
| cm | mm | Gr/m2 |

Performance

| | | | | | |
|---|---|---|---|---|---|
| Cleaning | θ | ι | ζ | α | η |
| symbols | | | | | |

| Shrinkage | Length 1-2-3% | | Width 1-2-3% | |
|---|---|---|---|---|
| Drape-ability | Length | cm | Width | cm |
| Flexibility | | | | |
| Lightfastness | | | | |
| ISO 105 B02 | | | | |
| (0-8) | Score: | | | |

Light (380-780 nm visible light field)
EN: 410 1998

| In % | White | Color |
|---|---|---|
| Transmission | — | |
| Reflection | — | |

Total solar energy transmittance
ISO 9050

| Solar factor | White | | Color | |
|---|---|---|---|---|
| Value “g tot” | | | | |
| Transparency | White | | Color | |
| Upholstery | CD | GD | SD | SC |
| BS 2543 | | | | |

| | |
|---|---|
| Abrasion | Rubs |
| BS 5690 | (Martindale) |
| Piling | Rubs |
| BS 5690 | (Martindale) |

| | | |
|---|---|---|
| Breakstrength | Length | Width |

| | | |
|---|---|---|
| BS 2576 | N | N |

| | | |
|---|---|---|
| Tearstrength | Length | Width |

| | | |
|---|---|---|
| BS 4303 | N | N |

| | | |
|---|---|---|
| Seamslippage | Length | Width |

| | | |
|---|---|---|
| BS 3320 6 mm | N | N |

| Visible soiling | 3 | 3 | 3-4 | 3-4 |
|---|---|---|---|---|
| BS 4948 | | | | |
| Protection | | | | |
| Flame retardant | | | | |

| | | |
|---|---|---|
| NFP 92-503 | M1 | M2 |
| DIN 4102 | B1 | B2 |
| BS 5852 Part 1 | Yes | No |
| (cig) | | |

Anti static (there is no standard test for this)
Anti bacterial (there is no standard test for this)
Anti allergic (there is no standard test for this)
Anti fungal (there is no standard test for this)
Environment

| | |
|---|---|
| Water repellent | |
| 3M-method (1-9) | Score: |
| Oil repellent | |
| 3M-method (1-9) | Score: |
| Stain resistant (dry) | |
| BASF-method (1-5) | Score: |
| Stain resistant (wet) | |
| BASF-method (1-5) | Score: |
| Soil-release | |
| BASF-method (1-5) | Score: |
| Recyclability | |
| Warmth-/cold insulation | |
| Sound insulation | |

TABLE 4

| FUNDAMENTAL | | |
|---|---|---|
| COMPONENTS | PROPERTIES | VALUES, UNITS |
| Base Material | | staple (mm) or |
| Natural | Length | filament (m) |
| Cellulose (Plant) | | um, also dtex |
| | | (or denier) |
| Cotton | Fineness (Diameter) | smooth, scaly, |
| Flax (Linen) | Surface Character | twisted, lobal, etc. |
| Hemp | | |
| Sisal | | |
| rugs | | |
| Protein (Animal) | | |
| Wool | | |
| Specialty Hair Fibers | | |
| Mohair | | |
| Silk | | |
| Filament (Cultivated) | | |
| Staple | | |
| Waste cultivated | | |
| Douppioni (Dupion) | | |
| Wild Silk | | |
| Manufactured | Any may have | |
| | components added to | |
| | the liquid fiber- | |
| | forming material, or | |
| | (synthetics) included | |
| | in polymerization | |
| | (some also applied as | |
| | a finish): | |
| | Most NB: | |
| | UV blocking esp. | |
| | (Polyamide) | |
| | FR Flame Retardant | |
| | Antistatic | |
| | Crease Resistant | |
| | Bioactive | |
| | Various | |
| | Encapsulated | |
| | Hydrophilic | |
| | More dyeable | |
| | Dull, matt (white | |
| | pigment) | |
| | Cut Resistance | |
| | (ceramic particles | |
| | in fiber) | |
| | Metallic Particles | |
| Cellulosic | | |
| Regenerated Cellulose | | |
| Viscose, Standard | | |
| Modal | | |
| Cupro (Cuprammonium) | | |
| Lyocell | | |
| Cellulose Compound | | |
| Acetate | | |
| Synthetic | Extruded filaments | |
| | may be Drawn | |
| | (oriented), for use as | |
| | Standard Filament | |
| | (yarn) or (from tow) | |
| | cut into Staple, then | |
| | can be Crimped; used | |
| | for Spun Yarn | |
| | Extruded filaments | |
| | may be Undrawn = | |
| | POY (partially | |
| | oriented yarn), for | |
| | Bulking or testuring— | |
| | see Textured Filament | |
| | Yarn | |
| Polyester | | |
| Polyamide (Nylon) | | |
| Aramid | | |
| Polyolefin (Olefin) | | |
| Polypropylene | | |
| Polyethylene | | |
| Acrylic | | |
| Modacrylic | | |
| Chlorofibre | | |
| Polyvinylchloride (Vinyon) | | |
| Polyvinylidenechloride | | |
| (Saran) | | |
| Vinylal (Vinal) | | |
| Biocomponent | | |
| Layered, Different | | |
| Refractive Indices | | |
| Mineral | | |
| Glass | | |
| Metal | | |
| Yarn Construction | | |
| Standard | | |
| Continuous Filament Yarn | | Fibers mess. In m |
| | | Thickness |
| | | (Gauge) + Width |
| Split-Film | | |
| Extruded | | |
| Monofilament | | |
| Multifilament | | |
| Standard | | |
| Textured or BCF (bulked | | |
| continuous filament) | | |
| Stretch | Heat Set | |
| False-Twist | | |
| Knit-Deknit | | |
| Edge-Crimp | | |
| Some stretch, some bulk | | |
| Stuffer Box, Gear, Tunnel | | |
| Crimped, No Stretch | | |
| Air-Textured | No Heat Set | |
| Loop-textured | | |
| Spun-like | Loops Very Small | |
| Spun Yarn | Staple fibers | Fibers meas, in mm |
| | Any may be Single, | 2-30 t/cm |
| | Ply, Cable Amount of | |
| | Twist varies | |
| Conventional Carded | | |
| Conventional Carded + | | |
| Combed | | |
| Non-Conventional | | |
| Open-end | | |
| Air-Jet | | |
| Direct | | |
| Fancy Yarn | | |
| Irregular Ply | May have Core, Effect | |
| | Ply, Binder Effect Ply | |
| | forms one of: | |
| | Elongated thickening | |
| | Small thickening | |
| | Open Loop or Closed | |
| | One ply wraps | |
| | around another | |
| Slub | | |
| Nub, Knop | | |
| Loop | | |
| Spiral or Corkscrew | | |
| Metallic | | |
| Film-coated aluminum | Film usually acetate or | |
| | polyester. | |
| Chenille | Expensive, made by | |
| | weaving | |
| Fabric Construction | | |
| Woven | For any, variations in | Warp/cm |
| | fiber and yarn type, | Weft/cm |
| | color, plus relative size | Thread count = |
| | and closeness of yarns | Warp & Weft/cm |
| Plain Weave | | |
| Balanced | | |
| Basket | | |
| Rib | | |
| Twill Weave | | |
| Warp-Face | | |
| Weft-Face | | |
| Irregular | | |
| Satin Weave | | |
| Warp-Face | | |
| Weft-Face | | |
| Dobby Weave | | |
| Crepe by weave | | |
| Structural Design | small, hard-edged | Max. 32 weft rows |
| Reversible and Double | 3-4 sets warp/weft | |
| Cloth | 3 sets warp, 2 sets | |
| | weft | |
| Pile Weave | Any vary in ground | Tufts/cm |
| | weave: plain or twill, | |
| | how close; in pile | |
| | density | |
| Warp Pile | | |
| Extra Warp Woven In | By Double Cloth (cut | Shot-terry |
| | pile), (carpet) | |
| | Overwire (cut or | |
| | uncut), Slack Tension | |
| | Warp (cut or uncut) | |
| Pile Hand-Tied (Oriental) | | Type of know |
| Weft Pile | | |
| Extra Weft Woven In | With Wale (Corduroy) | |
| | Or Without | |
| | (Velveteen) | |
| Chenille Yarn Weft | | |
| Leno Weave | Warp yarns crossed | |
| | in pairs | |
| Figures Woven Extra Yarns | | |
| Extra Warp | | |
| Lappet | | |
| Clip-Spot | | |
| Extra-Weft | | |
| Swivel | | |
| Clip-Spot | | |
| Jacquard Weave-structural | 2-5 sets warp/weft | |
| desgin | | |
| Knit | | |
| Warp | Can be Structural | Stitch density |
| | Design, especially | |
| | Raschel) | |
| | If yarns colored, | Wales/cm, |
| | effect lengthwise | |
| Tricot | Spring Beard needle, | Courses/cm |
| | Limited Range, Type | (Equiv. Of Gauge) |
| | Yarns | |
| Raschel | Latch needle, | |
| | Unlimited Range, | |
| | Type Yarns | |
| Simplex | Like a Double Tricot | |
| Tufted | | |
| Stitch-Knit (with yarn) | | |
| Braided | | |
| Twisted (Net & Leavers | | |
| type of lace | | |
| Felt | | |
| Nonwoven | | |
| Fiber Web Bonded | | |
| Adhesive-bonded | | |
| Heat-bonded | | |
| Needled | | |
| Spunbonded | | |
| Spunlaced | | |
| Stitch-Knit (no yarn) | | |
| Natural Fabric | | |
| Leather | | |
| Fur | | |
| Film | | |
| Foam | | |
| Compound—“Systems” | | |
| of fabrics joined together | | |
| Quilted | | |
| Laminated (Adhesive, Heat, | | |
| Foam + Heat) | | |
| Fabric Finish | | |
| Physical | | |
| Wash | | |
| Scour according to fiber | | |
| type | | |
| Stone Wash, Acid Wash, | | |
| etc. | | |
| Enzyme Wash (using | | |
| cellulase) = “biopolishing” | | |
| cotton | | |
| Full (wool) | | |
| Beetle (linen) | | |
| Sand (Emerize) | | |
| Tumble | | |
| Calender (press) | | |
| Nap, Brush, with or without | | |
| Shear | | |
| Singe, Gas | | |
| Heat Set | | |
| Chemical | | |
| Mercerize (Cotton) | | |
| Mothproof (Wool) | | |
| Impregnate | TTD: ISO 4880-1984 | |
| Flame Retardant | | |
| Stain, Soil Resistance | | |
| Water | | |
| Water & Oil (Flurocarbon) | | |
| Soil Release | | |
| Resin | | |
| Crease Restance | Wrinkel Recovery | |
| Durable Press | | |
| Coat | | |
| Waterproof | | |
| Leather-Like | | |
| Latex (Room Darken) | | |
| Flock Allover (Velvet-like, | | |
| Suede-like) | | |
| Reflective | | |
| Dye Color Technique | | |
| Spun-Dyed (Pigment, Dye | | |
| put in liquid fiber-forming | | |
| material) | | |
| Stock (fiber), Top, | Yarn can have | |
| Tow-Dyed, | Uniform or | |
| | Variable Color | |
| Yarn-Dyed | Yarn can have | |
| | Uniform or | |
| | Variable Color: | |
| Skein | Variable: | |
| | Space-Dyed | |
| Package-Dyed | Ikat (warp ikat, | |
| | weft ikat, couble ikat) | |
| Atmospheric | | |
| Pressure | | |
| Piece-Dyed | | |
| Atmospheric | | |
| Pressure | | |
| Pigment-Dyed (pigment | | |
| or dye bound to fabric | | |
| surface) | | |
| Type of Dye | | |
| Acid | | |
| Mordant, esp, | | |
| Chrome | | |
| Metal Colplex | | |
| Basic (some called | | |
| Cationic) | | |
| Disperse | | |
| Reactive (Feber-Reactive) | | |
| Vat | | |
| Naphthol (Azoic) | | |
| Sulfur | | |
| Applied Design | (applied after fabric | |
| | construction—except | |
| | warp print) | |
| Print | | |
| Color | Warp Print (Chine' | |
| | Design) “bleeding | |
| | edge”: on yarns | |
| | beamed for weaving, | |
| | by rotary, screen. | |
| | Direct Print, Transfer | |
| | Print | |
| Rotary | | |
| Screen | | |
| flat-screened | | |
| rotary-screened | | |
| Ink-Jet (Digital) | | |
| Block Print | | |
| Stencil | | |
| Transfer Print | | |
| Resist Print (followed by | | |
| Piece Dyeing) | | |
| Discharge Print | | |
| (followed by Direct) | | |
| Print Chemical | | |
| Burnt-out | | |
| Plisse' | | |
| Flock | Adhesive, Type of | |
| | Process affect | |
| | durability | |
| Pressure | | |
| Embossed | | |
| Moire' (cross rib | | |
| weave, 2 layers) | | |
| Embroider | | |
| Pleat | | |

| (1A) RESULTING CHARACTERISTICS | (1B) VALUES |
|---|---|
| Sensory Impact | |
| Behavior to Light | |
| Light Reflection | (0%-100%) |
| shiny/lustrous/glossy/polished, glazed, | |
| dull/matte (US Prefers matte) | |
| changeable (glitter, glimmer, iridescent, | |
| pearlescent, shot, etc.) | |
| Transparency | |
| sheer | |
| semi-sheer | |
| opaque | |
| Hand (Feel) | |
| cool | |
| warm | |
| soft | |
| smooth | |
| Xx to slippery | friction test |
| rough | |
| springy, wiry | crease recovery test |
| crisp | |
| stiff | |
| pliable, supple, fluid, limp, drapey | drape test |
| Surface Texture | |
| Nap or Pile | |
| Short Nap | |
| Medium Nap | each of these |
| Long Nap (Hairy/Furry) | can be further |
| Short Pile | specified as |
| Medium Pile | woven, knit, |
| Long Pile | tufted, flocked, |
| Dense Pile | twisted, embroidered or |
| Medium Density Pile | embossed, or whatever |
| Sparse Pile | |
| Rib or Cord | |
| Lengthwise | |
| Crosswise | |
| Pattern in Relief on Surface | |
| Texture From Fancy Yarn | |
| Irregular Ply | Slubby, Nubby |
| | (Knoppy), |
| | Loopy, Spiral or |
| | Corkscrew |
| Metallic | Glittering, Glimmering |
| Physical Characteristics and Performance | |
| Weight | Grams per sq. metre |
| | (g/m² |
| Thickness | Yarn, Fabric; mm |
| Strength | |
| Tensile Strength | newtons (N) |
| Tenacity (Fiber) | centinewtons per |
| | decitex |
| | (cN/dtex) close to grams |
| | per denier (gpd) |
| upholstery Tearing Strength | N |
| Resistance to Abrasion | various tests |
| Resistance to Piling | |
| Resistance to Snagging | Mace test, units, prob. |
| | 1-5 re photos |
| glass fiber | |
| Resistance to Flexing | |
| Seam Strength | N |
| Seam Slippage | |
| Modulus | esp. Wet Modulus re |
| | viscose |
| Elasticity | % |
| Crease Resistance | Crease Recovery test, or |
| | photos 1-5 |
| Dimensional Stability | |
| Shrink Resistance | 0%-18% |
| Soil Release | |
| Resistance to Stretching, Sagging | |
| Resistance to Static Electricity Generation | |
| Flame Resistance | France: NF-P92-50; |
| | Germany DIM 4102 |
| Water Repellency | 3M Method: 0-8 |
| Oil Repellency | 3M Method: 0-8 |
| Stain Resistance | Gray or Stain Scale: |
| | Grade 0 or 1-5 |
| Heat Insulation | Tog |
| Bioactivity | |
| Antibacterial | |
| Antifungal | |
| Resistance to Tendering by (UV) Light | |
| Colorfastness | |
| Fastness to Light | ISO 103B02 ‘blue scale’ |
| | 0-8; AATCC 1-8 |
| Fastness to Crocking | Gray or Stain Scale: |
| | Grade 0 or 1-5 |
| Fastness to Commercial Cleaning | |
| Fastness to Dry Cleaning | |
| Fastness to Wet Cleaning | |
| Fastness to Home Laundering | |
| Care Instructions | |
| Recyclability | |
| Conformity to, e.g., ISO 9000 | |
| Product | |
| Window Covering | |
| Curtain (includes all weights, net and glass | |
| curtains, drapes, etc.) | |
| Normal | |
| Careful Domestic | Sheer |
| Domestic | Light Filtering |
| Severe Domestic (or Compact) | Semi-Sheer |
| Severe Contract | Opaque |
| In-Between | Room Darkening |
| Net | |
| Blind | Differences according |
| Roman | to material made of and |
| | style: |
| Panel | aluminum; smooth or |
| | textured, |
| Vertical | PVC (vinyl): smooth or |
| Horizontal | woven-look, wood, |
| | rattan, |
| Venetian | pleated |
| Roller | |
| Upholstery, Slip Covers | |
| Furniture | |
| Cover Frame | |
| Loose Cushions | |
| Cushions | |
| Filling | |
| Trim | |
| Table Linen | |
| Table Cloth | |
| Place Mat | |
| Napkin | |
| Silence Cloth | |
| Bedding | |
| Bed Spread | |
| Sheets, Pillow Cases | |
| Comforter, Duvet | |
| Blanket | |
| Mattress Covers (Ticking) | |
| Bath | |
| Towel, Wash Cloth | |
| Bath Mat | |
| Shower Curtain | |
| Differences Face to Back as fabric | |
| made = “Technical Face,” | |
| “Technical Back“; not always the | |
| same as “Right” vs “Wrong” Side | |
| Reversible fabrics | |
| Plain Weave, pattern such as check | |
| yarn-dyed | |
| Dobby Weave Reversible (compound weave) | |
| Fabrics where technical Face is (usually) | |
| Right Side | |
| Twill weave fabrics of wool, silk | |
| family Right Hand | |
| (Cotton family may be Left or Right Hand) | |
| Satin weave filament warp float | |
| warpwise (Warp Face) | |
| (Cotton family may be Weft Face or | |
| Warp Face) | |
| More marked Surface Texture on one side | |
| (See preceding section on Surface | |
| Texture) | |
| Plain stitch knit with Lay-in on back of | |
| yarn that is Napped (lay-in on back of | |
| Fancy Yarn or if Silver Pile is used as | |
| right side) | |
| Tricot knit without colored or fancy | |
| yarn knitted in, and not printed or | |
| brushed | |
| Fabric Right Side will (usually); | |
| Be more lustrous | |
| Be more closely constructed | |
| Have tenter holes smaller | |
| Have fewer imperfections | |
| Be folded to inside as shipped | |
| from manufacturer | |

1. A method for identifying products of a selected type from a range of products, the method comprising:
storing in a database a record of at least one product, wherein at least one characteristics of the product is defined in terms of at least one primitive;
displaying a classification palette comprising at least one descriptor, wherein the at least one descriptor is utilized to identify at least one product;
storing in association with the at least one descriptor at least one primitive for defining a characteristic of the descriptor;
selecting at least one descriptor from the classification palette; and
identifying at least one product having at least one of the at least one primitive associated with the selected descriptor.

2. A method for selecting a fabric from a database based upon an identification of a color, composition, design, and supply, comprising:
establishing a connection with a database containing a record of at least one fabric in a range of fabrics, wherein the fabric is classified in the database according to at least one primitive selected from the group consisting of a color, a composition, a design, and a supply; wherein more than one primitive defines the fabric;
accessing a fabric classification scheme, wherein the fabric classification scheme provides at least one palette containing at least one descriptor for each strand identifying a plurality of characteristics associated with a fabric, wherein the strands further comprises a Color Strand, a composition strand, a design strand and a supply strand;
selecting at least descriptor for at least one strand to search for in the database;
converting the descriptor into at least one primitive;
searching the database for at least one fabric classified by the primitive;
repeating the conversion of the description into a primitive and the search for a fabric until all descriptors have been converted and fabrics searched for; and
returning as a result those fabrics which satisfy the descriptors selected from the classification palette.
